(19) United States
(12) Patent Application Publication
(10) Pub. No.: US 2026/0252638 A1
(43) Pub. Date: Aug. 27, 2026

(54) SYSTEM

(71) Applicant: SoftBank Group Corp., Tokyo (JP)

(72) Inventor: Hiroto YAMAGUCHI, Tokyo (JP)

(73) Assignee: SoftBank Group Corp., Tokyo (JP)

(21) Appl. No.: 19/541,408

(22) Filed: Feb. 17, 2026

(30) Foreign Application Priority Data
Feb. 21, 2025 (JP) 2025-026973

(51) Int. Cl. G06F 16/951; G06Q 10/06

(52) U.S. Cl. CPC G06F 16/951; G06Q 10/06

(57) ABSTRACT

The system according to the embodiment comprises a receiving unit, an analysis unit, a posting unit, a minutes creation unit, and a proposal unit. The receiving unit receives questions. The analysis unit analyzes the questions received by the receiving unit and generates answers. The posting unit posts the answers generated by the analysis unit to a chat field. The minutes creation unit analyzes video data of a meeting and creates minutes. The proposal unit proposes next actions based on the minutes created by the minutes creation unit.

### CROSS-REFERENCE TO RELATED APPLICATION

The present application claims priority to and incorporates by reference the entire contents of Japanese Patent Application No. 2025-026973 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem of inefficiency because resolving questions during online meetings, creating minutes, and proposing next actions are performed manually.

### SUMMARY OF THE INVENTION

The system according to the embodiment comprises a receiving unit, an analysis unit, a posting unit, a minutes creation unit, and a proposal unit. The receiving unit receives questions. The analysis unit analyzes the questions received by the receiving unit and generates answers. The posting unit posts the answers generated by the analysis unit to a chat field. The minutes creation unit analyzes video data of a meeting and creates minutes. The proposal unit proposes next actions based on the minutes created by the minutes creation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

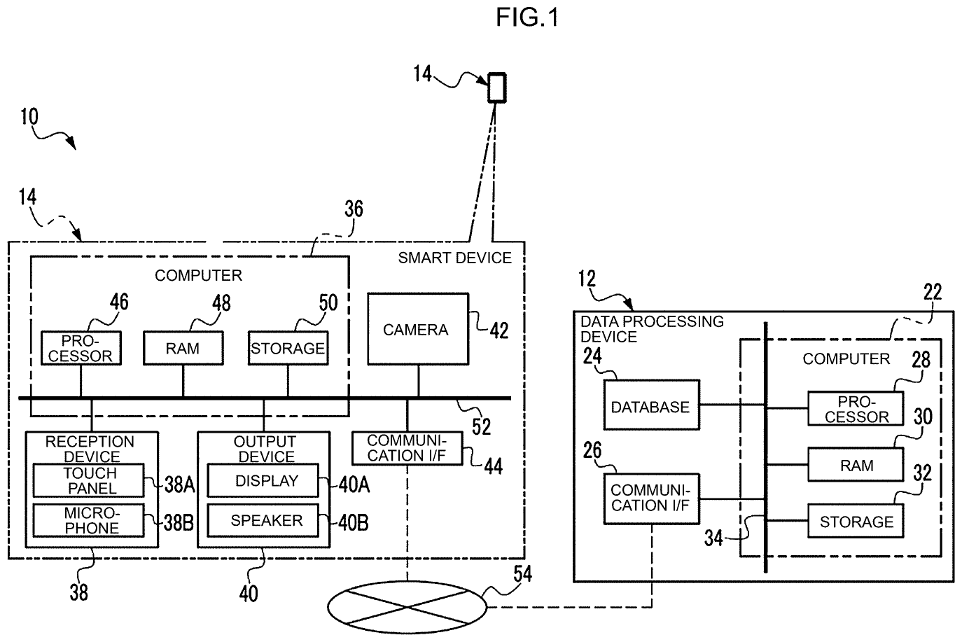

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

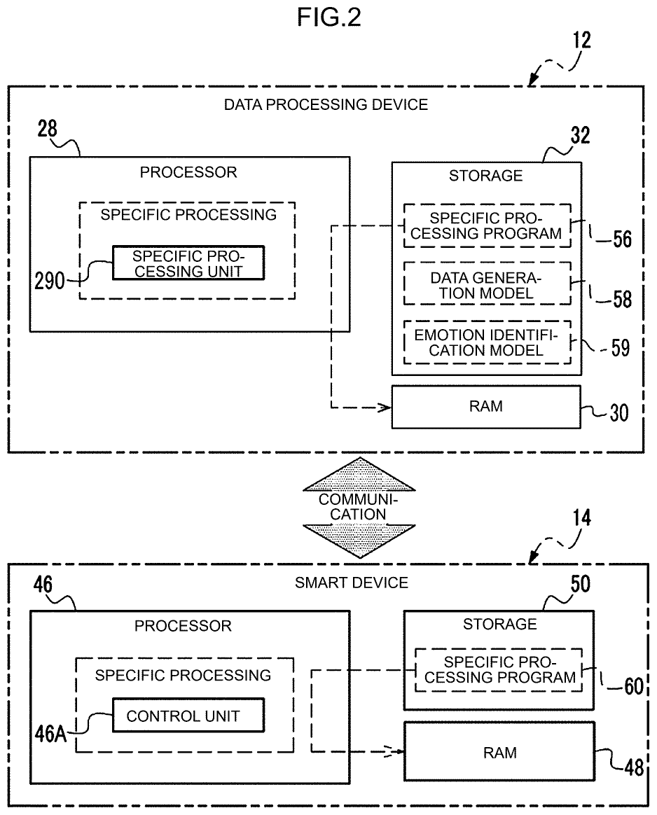

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system that provides answers to questions during online conferences and automates necessary miscellaneous tasks. This system allows users to ask questions to a generative AI by calling out “Hey, Generative AI” during a web conference. The generative AI analyzes the question and posts the answer to the chat field, enabling all participants to resolve their doubts simultaneously. Additionally, the system automatically creates minutes from the video data of the meeting and provides a function to propose next actions for unresolved issues during the meeting. This improves the efficiency of meetings and clarifies the next actions for all participants. For example, when a user calls out “Hey, Generative AI” during a web conference, the generative AI receives the question. The user only needs to input the specific question, such as “What is the progress of this project?” This information is input to the generative AI. Next, the generative AI analyzes the input question and generates an appropriate answer. The generative AI generates the optimal answer to the question based on pre-learned data. For example, in response to the question “What is the progress of this project?”, the generative AI generates an answer such as “The current progress is 50%.” The generated answer is posted to the chat field, allowing all participants to resolve their doubts at once. For example, when the answer generated by the generative AI is posted to the chat field, all participants can check the answer. Furthermore, the system provides a function to automatically create minutes from the video data of the meeting. The generative AI analyzes the video data of the meeting and generates minutes, such as summarizing the content of the meeting and outputting it as minutes. These minutes are shared with all participants. The system also provides a function to propose next actions for unresolved issues during the meeting. The generative AI analyzes the content of the meeting and identifies unresolved issues, proposing next actions such as “Discuss this issue at the next meeting.” This improves meeting efficiency and clarifies the next actions for all participants. Thus, the system enables answering questions and automating necessary miscellaneous tasks within online conferences. Specifically, the system is composed of multiple computer modules, including a speech recognition engine, natural language processing module, large language model, video analysis module, summary generation module, task extraction algorithm, and action recommendation engine, which operate in coordination. The system first converts the user's voice input to text using the speech recognition engine, then the natural language processing module extracts the question sentence from the utterance. The extracted question sentence is input to a pre-trained large language model (for example, a Transformer architecture with billions of parameters). The input data is a tokenized text sequence (e.g., “What is the progress of this project?”→[token ID sequence]), and the model is pre-trained on past meeting logs, documents, FAQ datasets, etc. Examples of input to the AI include natural language sentences such as “What are this week's sales?” and “When is the next delivery date?” The AI generates text based on probability distributions and returns natural language sentences such as “This week's sales are 1 million yen” or “The next delivery date is June 15.” The output is also generated as structured data (answer text, confidence score, related links, etc.) for automatic posting to the chat field. In subsequent processing, the posting unit performs threshold judgment (e.g., only posting answers with a confidence score of 0.8 or higher), elimination of duplicate questions, summarization and splitting of answers, and finally posts to the chat field. For the minutes creation function, the video analysis module extracts the audio stream from the meeting video, converts it to text using the speech recognition engine, and the summary generation module (for example, a hybrid model of extractive and generative summarization) summarizes the utterances in chronological order. Examples of input to the AI are time-series arrays of speech text (e.g., arrays of utterance text for each minute), and examples of output are summary sentences such as “Topic A was discussed at the beginning of the meeting, and issue B was raised 10 minutes later.” The task extraction algorithm extracts unresolved issues and action items from the minutes text, and the action recommendation engine generates next actions such as “Prioritize discussion of issue B at the next meeting.” These AI processes are executed at high speed on parallel computing clusters using GPUs, and, unlike conventional manual work or simple rule-based processing, realize semantic analysis and contextual understanding in high-dimensional vector spaces and multimodal (voice, text, video) integrated processing. As a technical effect, the system simultaneously achieves real-time resolution of doubts during meetings, automation of minutes creation, and efficient issue management, resulting in significant improvements in processing speed, reduction of human errors, homogenization of information sharing, and improved accuracy of post-meeting task management, thereby improving computer technology itself. Specific application fields include online meetings in companies, progress management of research and development projects, discussion records in educational settings, minutes creation for medical conferences, and support for meeting operations in government agencies.

The system according to the embodiment comprises a receiving unit, an analysis unit, a posting unit, a minutes creation unit, and a proposal unit. The receiving unit receives questions when a user calls out during a web conference. For example, when a user calls out “Hey, Generative AI,” the receiving unit receives the question. The analysis unit generates appropriate answers to questions based on pre-learned data. For example, the generative AI generates optimal answers to questions based on past question and answer datasets. The posting unit posts the generated answers to the chat field. For example, by posting the answer generated by the generative AI to the chat field, all participants can check the answer. The minutes creation unit summarizes the content of the meeting and outputs it as minutes. For example, the generative AI analyzes the video data of the meeting and generates minutes. The proposal unit analyzes the content of the meeting and proposes next actions for unresolved issues. For example, the generative AI analyzes the content of the meeting, identifies unresolved issues, and proposes next actions such as “Discuss this issue at the next meeting.” Thus, the system according to the embodiment enables answering questions and automating necessary miscellaneous tasks within online conferences. Each element—the receiving unit, analysis unit, posting unit, minutes creation unit, and proposal unit—may include processing by the generative AI. For example, the receiving unit may analyze the user's call using speech recognition technology and receive the question. The analysis unit may use the generative AI to generate optimal answers to questions. The posting unit may use the generative AI to post the generated answers to the chat field. The minutes creation unit may use the generative AI to summarize the content of the meeting and generate minutes. The proposal unit may use the generative AI to analyze the content of the meeting and propose next actions for unresolved issues. Specifically, the system may adopt a configuration in which each module—the receiving unit, analysis unit, posting unit, minutes creation unit, and proposal unit—is executed in a distributed manner on multiple computer nodes. The system receives the user's voice input at the receiving unit, converts the audio waveform data (sampling rate 16 kHz, 16,000 samples per second, one-dimensional array) to text using a speech recognition engine (for example, an acoustic model combining convolutional neural networks and recurrent neural networks). The speech recognition engine is pre-trained on a large amount of meeting audio data and also performs noise reduction and speaker separation. The receiving unit extracts the question sentence from the speech recognition result using a natural language processing module (for example, a BERT-based sentence classifier). The extracted question sentence is tokenized (subword-level ID sequence) and input as a token ID sequence (e.g., 512-dimensional integer array) to the large language model of the analysis unit (for example, a Transformer architecture with billions of parameters). Examples of input to the AI include natural language sentences such as “What is the progress of this project?” and “When is the next delivery date?”, which are supplied to the model as token ID sequences. The analysis unit retains past meeting logs, FAQs, and related documents as pre-learned data, and generates optimal answer sentences (e.g., “The current progress is 50%.”) by performing text generation based on probability distributions (e.g., calculating softmax probability distributions for each output token) in response to input questions. The output is passed to the posting unit as structured data including answer text, confidence score (e.g., 0.92), related links, etc. The posting unit automatically posts only answers with a confidence score of 0.8 or higher to the chat field, eliminates duplicate questions, and summarizes or splits answers. The minutes creation unit extracts the audio stream from meeting video data (e.g., H.264 format video plus audio stream), converts it to text using the speech recognition engine, and performs chronological summarization using a summary generation module (a hybrid model of extractive and generative summarization). Examples of input to the AI are arrays of utterance text for each minute (e.g., arrays of strings for each utterance), and examples of output are summary sentences such as “Topic A was discussed at the beginning of the meeting, and issue B was raised 10 minutes later.” The proposal unit analyzes the minutes text using a task extraction algorithm (for example, a combination of rule-based and BERT classifier) to extract unresolved issues and action items, and the action recommendation engine (for example, a reinforcement learning-based decision-making model) generates next actions such as “Prioritize discussion of issue B at the next meeting.” These AI processes are executed at high speed on parallel computing clusters using GPUs, and, unlike conventional manual work or simple rule-based processing, realize semantic analysis and contextual understanding in high-dimensional vector spaces and multimodal (voice, text, video) integrated processing. As a technical effect, the system simultaneously achieves real-time resolution of doubts during meetings, automation of minutes creation, and efficient issue management, resulting in significant improvements in processing speed, reduction of human errors, homogenization of information sharing, and improved accuracy of post-meeting task management, thereby improving computer technology itself. Specific application fields include online meetings in companies, progress management of research and development projects, discussion records in educational settings, minutes creation for medical conferences, and support for meeting operations in government agencies.

The receiving unit can receive questions when a user calls out during a web conference. For example, the receiving unit receives questions when a user calls out “Hey, Generative AI.” The user only needs to input the specific question. For example, the user inputs a question such as “What is the progress of this project?” This allows the user to easily submit questions during a web conference. Some or all of the above-described processing in the receiving unit may be performed using generative AI, or may be performed without using generative AI. For example, the receiving unit may analyze the user's call using speech recognition technology and receive the question. Specifically, the receiving unit obtains the user's voice input from a microphone and receives it as audio waveform data (for example, 16 kHz sampling, 16,000 samples per second, one-dimensional array). The receiving unit uses a speech recognition engine (for example, an acoustic model combining convolutional neural networks and recurrent neural networks) to convert the audio waveform data into text data. The speech recognition engine is pre-trained on a large amount of meeting audio data and simultaneously performs noise reduction and speaker separation. The receiving unit extracts the question sentence from the speech recognition result using a natural language processing module (for example, a BERT-based sentence classifier). The extracted question sentence is tokenized at the subword level and passed to the subsequent analysis unit as a token ID sequence (e.g., 512-dimensional integer array). Examples of input to the AI include natural language sentences such as “What is the progress of this project?” and “When is the next delivery date?”, which are supplied to the model as token ID sequences. When not using AI, it is also possible to extract question sentences using rule-based keyword extraction or simple voice command recognition. As a technical effect, the receiving unit provides an environment in which users can naturally input questions by voice or text during a web conference, greatly improving reception accuracy and convenience compared to conventional manual input or limited command-based reception. Specific application fields include online meetings in companies, Q&A in educational settings, real-time question reception in medical conferences, and support for meeting operations in government agencies.

The analysis unit can generate appropriate answers to questions based on pre-learned data. For example, the analysis unit generates optimal answers to questions based on pre-learned data. The generative AI generates optimal answers to questions based on past question and answer datasets. For example, in response to the question “What is the progress of this project?”, the generative AI generates an answer such as “The current progress is 50%.” By generating optimal answers based on pre-learned data, highly accurate answers to questions can be obtained. Some or all of the above-described processing in the analysis unit may be performed using generative AI, or may be performed without using generative AI. For example, the analysis unit may use generative AI to generate optimal answers to questions. Specifically, the analysis unit inputs the token ID sequence (e.g., 512-dimensional integer array) received from the receiving unit into a large language model (for example, a Transformer architecture with billions of parameters). The large language model retains past meeting logs, FAQs, and related documents as pre-learned data, and performs contextual understanding and semantic analysis using self-attention mechanisms in response to input questions. Examples of input to the AI include natural language sentences such as “What are this week's sales?” and “When is the next delivery date?”, which are supplied to the model as token ID sequences. The output from the AI is natural language sentences generated by text generation based on probability distributions (e.g., calculating softmax probability distributions for each output token), such as “This week's sales are 1 million yen” or “The next delivery date is June 15,” and is further output as structured data including answer text, confidence score (e.g., 0.92), related links, etc. In subsequent processing, the posting unit performs threshold judgment based on the confidence score, elimination of duplicate questions, summarization and splitting of answers, etc. When not using AI, it is also possible to generate answers using rule-based FAQ search or simple keyword matching. As a technical effect, the analysis unit realizes highly accurate answer generation based on contextual understanding and semantic inference, greatly improving the speed of resolving doubts and the quality of answers during meetings compared to conventional simple FAQ search or manual answer creation. Specific application fields include business support in companies, progress management of research and development projects, automatic response in educational settings, and interview support in medical settings.

The posting unit can post the generated answers to the chat field. For example, the posting unit posts the generated answers to the chat field. By posting the answer generated by the generative AI to the chat field, all participants can check the answer. Thus, posting the generated answers to the chat field enables all participants to resolve their doubts at once. Some or all of the above-described processing in the posting unit may be performed using generative AI, or may be performed without using generative AI. For example, the posting unit may use generative AI to post the generated answers to the chat field. Specifically, the posting unit receives structured data (answer text, confidence score, related links, etc.) from the analysis unit and automatically posts only answers with a confidence score of 0.8 or higher to the chat field. The posting unit also executes duplicate question elimination algorithms (for example, duplicate determination by vector similarity calculation) and answer summarization/splitting processing (for example, splitting long answers into multiple messages). Examples of input to the AI include structured data (e.g., {‘answer text’:‘The current progress is 50%.’, ‘confidence’: 0.92, ‘link’: ‘https:// . . . ’}), and output from the AI includes control signals such as posting permission flags, posting order, and posting timing. In subsequent processing, the chat system API is called to actually post the answer. When not using AI, it is also possible to control posting using simple conditional branching or queuing. As a technical effect, the posting unit automatically determines the confidence and duplication of answers and posts them to the chat field at appropriate timing and order, thereby realizing homogenization of information sharing and efficient meeting progress. Specific application fields include online meetings in companies, sharing of Q&A in educational settings, sharing of diagnostic results in medical conferences, and support for meeting progress in government agencies.

The minutes creation unit can summarize the content of the meeting and output it as minutes. For example, the minutes creation unit summarizes the content of the meeting and outputs it as minutes. The generative AI analyzes the video data of the meeting and generates minutes. For example, the content of the meeting is summarized and output as minutes. Thus, summarizing the content of the meeting and outputting it as minutes enables efficient recording of the meeting content. Some or all of the above-described processing in the minutes creation unit may be performed using generative AI, or may be performed without using generative AI. For example, the minutes creation unit may use generative AI to summarize the content of the meeting and generate minutes. Specifically, the minutes creation unit extracts the audio stream from meeting video data (e.g., H.264 format video plus audio stream), converts it to text using the speech recognition engine, and performs chronological summarization using a summary generation module (a hybrid model of extractive and generative summarization). Examples of input to the AI are arrays of utterance text for each minute (e.g., arrays of strings for each utterance), and examples of output from the AI are summary sentences such as “Topic A was discussed at the beginning of the meeting, and issue B was raised 10 minutes later.” The minutes creation unit generates structured minutes data that includes not only summary sentences but also speaker information, timestamps, importance scores, etc. In subsequent processing, the minutes data is automatically saved to cloud storage or an internal document management system and shared with all participants. When not using AI, it is also possible to summarize using rule-based key phrase extraction or simple aggregation of utterances. As a technical effect, the minutes creation unit realizes fast and highly accurate automatic summarization and recording of meeting content compared to conventional manual minutes creation, improving the efficiency of information sharing and reducing human errors. Specific application fields include meeting records in companies, progress records of research and development projects, discussion summarization in educational settings, minutes creation for medical conferences, and support for meeting operations in government agencies.

The proposal unit can analyze the content of the meeting and propose next actions for unresolved issues. For example, the proposal unit analyzes the content of the meeting and proposes next actions for unresolved issues. The generative AI analyzes the content of the meeting, identifies unresolved issues, and proposes next actions such as “Discuss this issue at the next meeting.” Thus, analyzing the content of the meeting and proposing next actions for unresolved issues clarifies the next actions to be taken. Some or all of the above-described processing in the proposal unit may be performed using generative AI, or may be performed without using generative AI. For example, the proposal unit may use generative AI to analyze the content of the meeting and propose next actions for unresolved issues. Specifically, the proposal unit analyzes the minutes text received from the minutes creation unit using a task extraction algorithm (for example, a combination of rule-based and BERT classifier) to extract unresolved issues and action items. Examples of input to the AI include minutes text (e.g., strings such as “Issue B remained unresolved”), and output from the AI includes issue lists (e.g., {‘issue’:‘Issue B’, ‘status’:‘unresolved’}) and action candidates (e.g., “Prioritize discussion of issue B at the next meeting”). The proposal unit uses an action recommendation engine (for example, a reinforcement learning-based decision-making model) to generate optimal next actions by considering the context of the meeting and past action history. In subsequent processing, the proposal content is automatically inserted into the chat field or minutes and notified to participants. When not using AI, it is also possible to extract tasks and propose actions using simple rule-based methods. As a technical effect, the proposal unit automatically identifies unresolved issues during meetings and clarifies the next actions to be taken, thereby realizing efficient issue management and improved accuracy of post-meeting task execution. Specific application fields include project management in companies, issue tracking in research and development, proposal of action items in educational settings, support for medical planning in medical settings, and business improvement proposals in government agencies.

The receiving unit can estimate the user's emotion and adjust the timing of receiving questions based on the estimated emotion of the user. For example, the receiving unit estimates the user's emotion and adjusts the timing of receiving questions based on the estimated emotion. For example, if the user is nervous, the generative AI delays the timing of receiving questions to allow time for relaxation. If the user is excited, the generative AI receives questions immediately and responds quickly. If the user is tired, the generative AI adjusts the timing of receiving questions and encourages a break. Thus, by adjusting the timing of receiving questions according to the user's emotion, questions can be received at more appropriate times. Emotion estimation is realized using an emotion engine or emotion estimation function by generative AI, such as a text generative AI (e.g., LLM) or multimodal generative AI, but is not limited to these examples. Some or all of the above-described processing in the receiving unit may be performed using generative AI, or may be performed without using generative AI. For example, the receiving unit may use generative AI to estimate the user's emotion and adjust the timing of receiving questions. Specifically, the receiving unit simultaneously obtains multiple modal data such as the user's voice input, facial images, and text utterances, and inputs them to an emotion estimation engine (for example, an ensemble model of voice emotion recognition CNN, facial expression recognition CNN, and text emotion classification BERT). The emotion estimation engine preprocesses each modality—audio waveform (16 kHz sampling, 16,000 samples per second, one-dimensional array), facial image (224×224 pixel RGB image), and utterance text (subword token ID sequence)—and converts them into high-dimensional vectors in the feature extraction layer. Examples of input to the AI include “audio waveform with trembling voice,” “smiling facial image,” and utterance text such as “I'm a little nervous.” The emotion estimation engine outputs emotion labels for each modality (e.g., nervousness, excitement, fatigue, relaxation) and their probability distributions (e.g., nervousness 0.7, excitement 0.1, fatigue 0.1, relaxation 0.1). Examples of output include score vectors such as “nervousness: 0.75,” “relaxation: 0.15,” or labels such as “current emotion: nervous.” The receiving unit applies a question reception timing control algorithm (for example, 5-second delay if nervousness is 0.6 or higher, immediate reception if excitement is 0.7 or higher, break suggestion if fatigue is 0.5 or higher) based on these emotion estimation results and dynamically determines the reception timing. In subsequent processing, the reception timing control signal is sent to the reception UI, and guidance such as “Please wait a moment,” “You may ask your question now,” or “We recommend a break” is displayed on the user interface. When not using AI, it is also possible to adjust timing using simple threshold judgment based on voice volume or utterance intervals. As a technical effect, the receiving unit realizes flexible reception timing adjustment according to the user's psychological state and situation, improving user experience, reducing stress when inputting questions, and facilitating smooth meeting progress, thereby improving computer technology itself. Specific application fields include stress management in online meetings in companies, support for speaking in educational settings, psychological consideration for patients and doctors in medical conferences, and promotion of speaking in resident briefings in government agencies.

The receiving unit can analyze the user's past question history and select an appropriate receiving method. For example, the receiving unit analyzes the user's past question history and selects the optimal receiving method. For example, the generative AI automatically proposes related questions based on the content of questions frequently asked by the user in the past. The generative AI also selects the optimal question receiving method (voice, text, etc.) based on the user's past question history. Furthermore, the generative AI analyzes the user's past question history and proposes the optimal question receiving method for specific time periods. Thus, by analyzing the user's past question history, the optimal receiving method can be selected. Some or all of the above-described processing in the receiving unit may be performed using generative AI, or may be performed without using generative AI. For example, the receiving unit may use generative AI to analyze the user's past question history and select the optimal receiving method. Specifically, the receiving unit retains a question history database for each user (e.g., a structured table including question content, reception date and time, reception method, time required for response, satisfaction feedback, etc.) and inputs it to a history analysis engine (for example, time-series clustering plus recommendation-type large language model). The history analysis engine preprocesses question content as token ID sequences (e.g., 512-dimensional integer arrays), reception method as category labels (e.g., voice, text, image), reception date and time as timestamps (e.g., UNIX time), and satisfaction as scores (e.g., 1-5), and generates feature vectors for each user. Examples of input to the AI include “list of question contents for the past month,” “reception method history (voice: 10 times, text: 5 times),” and “satisfaction score array (4, 5, 3, 5, 4).” The history analysis engine performs frequent topic extraction (e.g., LDA topic model), analysis of reception method usage trends (e.g., prioritizing voice reception for users who use voice reception frequently), and analysis of behavioral patterns by time period (e.g., text in the morning, voice in the afternoon), and outputs the optimal reception method and related question candidates. Examples of output include “recommended reception method: voice” and “related question candidates: ‘When is the next delivery date?’ ‘Progress report?’” In subsequent processing, the recommended reception method and related questions are automatically displayed on the reception UI, allowing the user to select them with a single click. When not using AI, it is also possible to propose reception methods using simple frequency aggregation or rule-based time period judgment. As a technical effect, the receiving unit realizes personalized selection of reception methods based on each user's usage trends and past behavioral patterns, improving reception efficiency, user satisfaction, and optimizing meeting progress, thereby improving computer technology itself. Specific application fields include individualized support in online meetings in companies, optimization of question reception for each student in educational settings, reception support according to patient attributes in medical settings, and automation of resident service counters in government agencies.

The receiving unit can perform filtering at the time of receiving a question based on the user's current project or field of interest. For example, the receiving unit performs filtering at the time of receiving a question based on the user's current project or field of interest. For example, only questions related to the project the user is currently working on are received. Questions related to the user's field of interest are also preferentially received. Furthermore, questions are filtered and received according to the user's project progress. Thus, by filtering questions based on the user's current project or field of interest, questions with high relevance can be received. Some or all of the above-described processing in the receiving unit may be performed using generative AI, or may be performed without using generative AI. For example, the receiving unit may use generative AI to filter questions based on the user's current project or field of interest. Specifically, the receiving unit retains a project management database for each user (e.g., a structured table including project ID, progress status, field of interest tags, related document links, etc.), and inputs the question sentence entered at the time of reception (e.g., token ID sequence) and the user's project/field of interest information to a filtering engine (for example, BERT-based semantic similarity calculation plus rule-based filter). The filtering engine calculates the semantic vector similarity (e.g., cosine similarity of 0.8 or higher) between the question sentence and project/field of interest tags, and extracts only questions with high relevance as reception candidates. Examples of input to the AI include “question sentence: ‘What is the progress this week?’” “project tag: AI development” “field of interest tag: natural language processing.” Examples of output include “reception permission: permitted,” “relevance score: 0.85,” and “priority: high.” In subsequent processing, only questions with high relevance are displayed on the reception UI, and other questions are received with low priority or not displayed. When not using AI, it is also possible to filter using keyword matching or simple tag matching. As a technical effect, the receiving unit realizes question reception tailored to the user's work status and interests, eliminating irrelevant questions, improving meeting progress efficiency, and enhancing information accuracy, thereby improving computer technology itself. Specific application fields include project management meetings in companies, field-specific Q&A in research and development, subject-specific question reception in educational settings, and department-specific question reception in medical settings.

The receiving unit can estimate the user's emotion and determine the priority of questions to be received based on the estimated emotion of the user. For example, the receiving unit estimates the user's emotion and determines the priority of questions to be received based on the estimated emotion. For example, if the user is nervous, the generative AI prioritizes receiving questions of low importance to help the user relax. If the user is excited, the generative AI prioritizes receiving questions of high importance and responds quickly. If the user is tired, the generative AI prioritizes receiving simple questions to reduce the burden. Thus, by determining the priority of questions to be received according to the user's emotion, more appropriate questions can be received preferentially. Emotion estimation is realized using an emotion engine or emotion estimation function by generative AI, such as a text generative AI (e.g., LLM) or multimodal generative AI, but is not limited to these examples. Some or all of the above-described processing in the receiving unit may be performed using generative AI, or may be performed without using generative AI. For example, the receiving unit may use generative AI to estimate the user's emotion and determine the priority of questions to be received. Specifically, the receiving unit inputs multiple modal input data such as the user's voice, facial images, and utterance text to an emotion estimation engine (for example, an ensemble model of voice emotion recognition CNN, facial expression recognition CNN, and text emotion classification BERT), which outputs emotion labels (nervousness, excitement, fatigue, relaxation, etc.) and their probability distributions. Examples of input to the AI include “audio waveform with trembling voice,” “smiling facial image,” and utterance text such as “I'm tired today.” The output from the emotion estimation engine is a score vector such as “nervousness: 0.65,” “excitement: 0.2,” “fatigue: 0.1,” “relaxation: 0.05.” The receiving unit inputs the emotion estimation results and the list of questions waiting for reception (including importance scores and difficulty labels for each question) to a priority determination algorithm (for example, weighted score calculation of emotion state×question importance) and dynamically determines the reception order. For example, if nervousness is high, questions of low difficulty are received first; if excitement is high, questions of high importance are prioritized; if fatigue is high, simple questions are prioritized. Examples of output include “reception order list: Question A→Question C→Question B” and “priority score for each question.” In subsequent processing, questions are displayed on the reception UI with priority, and guidance is provided to make it easier for the user to select. When not using AI, it is also possible to receive questions in a fixed order based on simple question difficulty or importance labels. As a technical effect, the receiving unit realizes reception order control tailored to the user's psychological state, improving user experience, facilitating smooth meeting progress, and reducing stress, thereby improving computer technology itself. Specific application fields include support for speaking in online meetings in companies, guidance for students' questions in educational settings, patient psychological consideration in medical settings, and promotion of speaking in resident briefings in government agencies.

The receiving unit can prioritize receiving questions with high relevance based on the user's geographic location information at the time of receiving a question. For example, the receiving unit prioritizes receiving questions with high relevance based on the user's geographic location information at the time of receiving a question. For example, if the user is in a specific region, questions related to that region are prioritized. Questions related to nearby projects are also prioritized based on the user's location information. Furthermore, if the user is on the move, questions related to the current location are prioritized. Thus, by prioritizing receiving questions with high relevance based on the user's geographic location information, more appropriate questions can be received. Some or all of the above-described processing in the receiving unit may be performed using generative AI, or may be performed without using generative AI. For example, the receiving unit may use generative AI to consider the user's geographic location information and prioritize receiving questions with high relevance. Specifically, the receiving unit inputs geographic location data obtained from the user's device (e.g., latitude and longitude floating-point values, Wi-Fi location information, IP address, etc.) to a location information analysis engine (for example, geospatial clustering plus semantic similarity calculation AI). The location information analysis engine calculates the spatial distance and semantic relevance between the user's current location and the geographic metadata in the project/meeting/question database (e.g., project location, region tags, related event information, etc.). Examples of input to the AI include “user location: 35.6895, 139.6917,” “project A location: 35.6890, 139.6920,” and “question sentence: ‘What is the local progress?’” Examples of output include “relevance score: 0.92,” “priority reception flag: True,” and “recommended question list.” The receiving unit prioritizes questions with high relevance scores as reception candidates and displays them preferentially on the reception UI. If the user is on the move, questions and projects related to the current location are automatically extracted, and reception candidates are dynamically switched. When not using AI, it is also possible to prioritize reception using simple geographic distance threshold judgment or region tag matching. As a technical effect, the receiving unit realizes question reception tailored to the user's current location and movement status, improving on-site responsiveness, providing region-specific information, and optimizing meeting progress, thereby improving computer technology itself. Specific application fields include on-site work support meetings, resident briefings in regional government, regional collaboration meetings in medical settings, and classroom-specific question reception in educational settings.

The receiving unit can analyze the user's social media activity at the time of receiving a question and receive relevant questions. For example, the receiving unit analyzes the user's social media activity at the time of receiving a question and receives relevant questions. For example, the content of the user's social media posts is analyzed, and relevant questions are prioritized. Related questions are also proposed based on the user's interests on social media. Furthermore, the user's social media activity history is analyzed to receive optimal questions. Thus, by analyzing the user's social media activity, relevant questions can be received. Some or all of the above-described processing in the receiving unit may be performed using generative AI, or may be performed without using generative AI. For example, the receiving unit may use generative AI to analyze the user's social media activity and receive relevant questions. Specifically, the receiving unit inputs social media post data obtained with the user's permission (e.g., post text, hashtags, post date and time, number of likes, number of comments, etc., as structured data) to a social analysis engine (for example, BERT-based topic extraction plus time-series clustering plus recommendation AI). The social analysis engine preprocesses post text as token ID sequences, hashtags as category labels, and post date and time as timestamps, and extracts the user's topics of interest and activity trends as high-dimensional vectors. Examples of input to the AI include “post text: ‘About the latest trends in AI technology,’” “hashtag: # AI # meeting,” and “post history: past month.” Examples of output include “topic of interest: AI technology” and “recommended question list: ‘What is the progress of the AI project?’ ‘What is the status of the introduction of the latest technology?’” The receiving unit prioritizes questions with high relevance based on the social analysis results and automatically displays them on the reception UI. When not using AI, it is also possible to extract related questions using simple keyword matching or hashtag aggregation. As a technical effect, the receiving unit realizes question reception tailored to the user's latest interests and activity trends, improving relevance to meeting content, user satisfaction, and optimizing information sharing, thereby improving computer technology itself. Specific application fields include internal SNS-linked meetings in companies, Q&A on the latest topics in research and development, question reception linked to student SNS activity in educational settings, and expert network collaboration in medical settings.

The analysis unit can estimate the user's emotion and adjust the expression method of answers based on the estimated emotion of the user. For example, the analysis unit estimates the user's emotion and adjusts the expression method of answers based on the estimated emotion. For example, if the user is nervous, the generative AI generates simple and easy-to-understand answers. If the user is relaxed, the generative AI generates answers with detailed explanations. If the user is excited, the generative AI generates visually appealing answers. Thus, by adjusting the expression method of answers according to the user's emotion, more appropriate answers can be provided. Emotion estimation is realized using an emotion engine or emotion estimation function by generative AI, such as a text generative AI (e.g., LLM) or multimodal generative AI, but is not limited to these examples. Some or all of the above-described processing in the analysis unit may be performed using generative AI, or may be performed without using generative AI. For example, the analysis unit may use generative AI to estimate the user's emotion and adjust the expression method of answers. Specifically, the analysis unit simultaneously obtains multiple modal data such as the user's voice input, facial images, and utterance text, and inputs them to an emotion estimation engine (for example, an ensemble model of voice emotion recognition CNN, facial expression recognition CNN, and text emotion classification BERT). The emotion estimation engine preprocesses each modality—audio waveform (16 kHz sampling, 16,000 samples per second, one-dimensional array), facial image (224×224 pixel RGB image), and utterance text (subword token ID sequence)—and converts them into high-dimensional vectors in the feature extraction layer. Examples of input to the AI include “audio waveform with trembling voice,” “smiling facial image,” and utterance text such as “I'm a little nervous.” The emotion estimation engine outputs emotion labels for each modality (e.g., nervousness, excitement, fatigue, relaxation) and their probability distributions (e.g., nervousness 0.7, excitement 0.1, fatigue 0.1, relaxation 0.1). Examples of output include score vectors such as “nervousness: 0.75,” “relaxation: 0.15,” or labels such as “current emotion: nervous.” The analysis unit uses these emotion estimation results to provide output style control parameters (e.g., conciseness, level of detail, visual element insertion flag, etc.) to the answer generation module (for example, a Transformer architecture with billions of parameters) and performs text generation. Examples of input to the AI include “question sentence: ‘What is the progress of this project?’” “emotion state: nervous,” “style control: concise.” Examples of output from the AI include “The progress is 50%.” (concise mode), “The current progress is 50%. For details, please refer to the project management sheet.” (detailed mode), and “The progress is 50%. See the graph here→URL” (with visual elements). In subsequent processing, the posting unit may add guidance or supplementary information according to the user's emotion state when posting the answer text to the chat field. When not using AI, it is also possible to adjust the expression using simple template switching or rule-based style selection. As a technical effect, the analysis unit realizes flexible answer expression control tailored to the user's psychological state and situation, improving user experience, optimizing information transmission, and facilitating smooth meeting progress, thereby improving computer technology itself. Specific application fields include Q&A in online meetings in companies, optimization of explanations for each student in educational settings, psychological consideration for patients in medical settings, and information provision in resident briefings in government agencies.

The analysis unit can adjust the level of detail of analysis based on the importance of the question at the time of analyzing the question. For example, the analysis unit adjusts the level of detail of analysis based on the importance of the question at the time of analyzing the question. For important questions, the generative AI performs detailed analysis. For less important questions, the generative AI performs concise analysis. The generative AI also adjusts the priority of analysis according to the importance of the question. Thus, by adjusting the level of detail of analysis based on the importance of the question, more appropriate analysis can be performed. Some or all of the above-described processing in the analysis unit may be performed using generative AI, or may be performed without using generative AI. For example, the analysis unit may use generative AI to adjust the level of detail of analysis based on the importance of the question. Specifically, the analysis unit receives the question sentence (token ID sequence) from the receiving unit and the importance score assigned to each question (e.g., real value from 0.0 to 1.0) as input. The analysis unit controls branching of the analysis pipeline according to the importance score, selecting detailed analysis mode (e.g., full-text search of related documents plus ensemble of multiple models plus generation with evidence) for high importance, and simple analysis mode (e.g., FAQ search plus summary generation only) for low importance. Examples of input to the AI include “question sentence: ‘What are this week's sales?’” “importance: 0.95,” “question sentence: ‘What time is lunch?’” “importance: 0.2.” Examples of output from the AI include, in detailed analysis mode, “This week's sales are 1 million yen. For details, please refer to the sales management sheet for June 2024. Evidence: sales management sheet URL,” and in simple analysis mode, “Lunch is at 12 o'clock.” The analysis unit dynamically allocates analysis resources (GPU computation time, number of external API calls, etc.) based on the importance score to optimize overall system computational efficiency and response quality. In subsequent processing, the posting unit may control the posting method or display priority according to the confidence and level of detail of the answer. When not using AI, it is also possible to switch the level of detail of analysis using simple conditional branching or rule-based methods. As a technical effect, the analysis unit realizes flexible control of the level of detail of analysis according to the importance of the question, optimizing computational resource utilization, improving response quality, and facilitating efficient meeting progress, thereby improving computer technology itself. Specific application fields include priority analysis of important cases in business support in companies, detailed analysis of exam preparation questions in educational settings, emergency assessment in medical interviews, and priority analysis of important topics in government agencies.

The analysis unit can apply different analysis algorithms according to the category of the question at the time of analyzing the question. For example, the analysis unit applies different analysis algorithms according to the category of the question at the time of analyzing the question. For technical questions, the generative AI applies specialized analysis algorithms. For business-related questions, the generative AI applies business-oriented analysis algorithms. For general questions, the generative AI applies general-purpose analysis algorithms. Thus, by applying different analysis algorithms according to the category of the question, more appropriate analysis can be performed. Some or all of the above-described processing in the analysis unit may be performed using generative AI, or may be performed without using generative AI. For example, the analysis unit may use generative AI to apply different analysis algorithms according to the category of the question. Specifically, the analysis unit inputs the question sentence (token ID sequence) received from the receiving unit to a category classifier (for example, a BERT-based sentence classification model), which automatically determines category labels such as “technical,” “business,” or “general.” Examples of input to the AI include “question sentence: ‘What is the learning rate of the AI model?’” “question sentence: ‘What is the sales target for this term?’” “question sentence: ‘What time is lunch?’” Examples of output from the AI include “category: technical,” “category: business,” and “category: general.” The analysis unit applies different analysis algorithms according to the category determination result: for technical category, an analysis pipeline including extraction of technical terms, technical literature search, and formula generation; for business category, financial data search and decision support model; for general category, FAQ search and summary generation only. For example, for the technical question “What is the learning rate of the AI model?”, the answer generated is “The learning rate is 0.001. For details, please refer to the project specification.” For the business question “What is the sales target for this term?”, the answer generated is “The sales target for this term is 20 million yen. For details, please refer to the business plan.” In subsequent processing, the posting unit may control the answer display method or priority according to the category. When not using AI, it is also possible to perform analysis using rule-based keyword matching or template switching by category. As a technical effect, the analysis unit realizes optimal selection of analysis algorithms according to the content of the question, improving response accuracy, ensuring expertise, and facilitating efficient meeting progress, thereby improving computer technology itself. Specific application fields include automatic response in technical, management, and general meetings in companies, subject-specific question analysis in educational settings, department-specific interview support in medical settings, and field-specific Q&A in government agencies.

The analysis unit can estimate the user's emotion and adjust the length of the answer based on the estimated emotion of the user. For example, the analysis unit estimates the user's emotion and adjusts the length of the answer based on the estimated emotion. For example, if the user is in a hurry, the generative AI generates short, concise answers. If the user is relaxed, the generative AI generates longer answers with detailed explanations. If the user is excited, the generative AI generates visually appealing answers. Thus, by adjusting the length of the answer according to the user's emotion, more appropriate answers can be provided. Emotion estimation is realized using an emotion engine or emotion estimation function by generative AI, such as a text generative AI (e.g., LLM) or multimodal generative AI, but is not limited to these examples. Some or all of the above-described processing in the analysis unit may be performed using generative AI, or may be performed without using generative AI. For example, the analysis unit may use generative AI to estimate the user's emotion and adjust the length of the answer. Specifically, the analysis unit inputs multiple modal input data such as the user's voice, facial images, and utterance text to an emotion estimation engine (voice emotion recognition CNN plus facial expression recognition CNN plus text emotion classification BERT ensemble model), which outputs emotion labels (e.g., in a hurry, relaxed, excited) and their probability distributions. Examples of input to the AI include “fast speech audio waveform,” “calm facial image,” and utterance text such as “I'm in a hurry.” The output from the emotion estimation engine is a score vector such as “in a hurry: 0.8,” “relaxed: 0.15,” “excited: 0.05.” The analysis unit uses the emotion estimation results to provide output length control parameters (e.g., maximum number of tokens, detail flag, visual element insertion flag, etc.) to the answer generation module (large language model) and performs text generation. Examples of input to the AI include “question sentence: ‘What are this week's sales?’” “emotion state: in a hurry,” “output length: short.” Examples of output from the AI include “This week's sales are 1 million yen” (short mode), “This week's sales are 1 million yen. For details, please refer to the sales management sheet” (long mode), and “This week's sales are 1 million yen. See the graph here→URL” (with visual elements). In subsequent processing, the posting unit may control the posting method or display priority according to the length and expression of the answer. When not using AI, it is also possible to generate answers using template switching or rule-based output length control. As a technical effect, the analysis unit realizes flexible control of answer length tailored to the user's psychological state and situation, improving user experience, optimizing information transmission, and facilitating smooth meeting progress, thereby improving computer technology itself. Specific application fields include instant response in online meetings in companies, optimization of explanations for each student in educational settings, psychological consideration for patients in medical settings, and information provision in resident briefings in government agencies.

The analysis unit can determine the priority of analysis based on the submission timing of the question at the time of analyzing the question. For example, the analysis unit determines the priority of analysis based on the submission timing of the question at the time of analyzing the question. For recently submitted questions, the generative AI performs analysis with priority. For older questions, the generative AI analyzes them later. The generative AI also adjusts the priority of analysis according to the submission timing of the question. Thus, by determining the priority of analysis based on the submission timing of the question, more appropriate analysis can be performed. Some or all of the above-described processing in the analysis unit may be performed using generative AI, or may be performed without using generative AI. For example, the analysis unit may use generative AI to determine the priority of analysis based on the submission timing of the question. Specifically, the analysis unit receives the question sentence (token ID sequence) and submission time (e.g., UNIX timestamp) from the receiving unit as input. The analysis unit sorts the questions in the analysis queue by newness or chronological order based on the submission time and applies a priority determination algorithm (e.g., FIFO, LIFO, time-weighted priority calculation, etc.). Examples of input to the AI include “question sentence: ‘What are this week's sales?’” “submission time: 1718000000,” “question sentence: ‘What were last week's sales?’” “submission time: 1717000000.” Examples of output from the AI include “priority list: Question A→Question B” and “priority score for each question.” The analysis unit dynamically controls the allocation of analysis resources and response timing according to the submission timing, prioritizing questions that require real-time response. In subsequent processing, the posting unit may control the posting order or notification timing of analysis results. When not using AI, it is also possible to determine priority using simple chronological sorting or rule-based methods. As a technical effect, the analysis unit realizes flexible priority control according to the submission timing of questions, improving real-time response, reducing response delay, and optimizing meeting progress, thereby improving computer technology itself. Specific application fields include priority response to new questions in online meetings in companies, real-time Q&A in educational settings, emergency assessment in medical interviews, and automation of resident service counters in government agencies.

The analysis unit can adjust the order of analysis based on the relevance of the question at the time of analyzing the question. For example, the analysis unit adjusts the order of analysis based on the relevance of the question at the time of analyzing the question. For highly relevant questions, the generative AI performs analysis with priority. For less relevant questions, the generative AI analyzes them later. The generative AI also adjusts the order of analysis according to the relevance of the question. Thus, by adjusting the order of analysis based on the relevance of the question, more appropriate analysis can be performed. Some or all of the above-described processing in the analysis unit may be performed using generative AI, or may be performed without using generative AI. For example, the analysis unit may use generative AI to adjust the order of analysis based on the relevance of the question. Specifically, the analysis unit receives the question sentence (token ID sequence) from the receiving unit and information on meeting topics or ongoing project information (e.g., topic vectors, project tags, etc.) as input. The analysis unit calculates the semantic vector similarity (e.g., BERT-based cosine similarity calculation) between the question sentence and meeting topic, and assigns a relevance score (0.0-1.0). Examples of input to the AI include “question sentence: ‘What is the learning rate of the AI model?’” “meeting topic: AI development,” “question sentence: ‘What time is lunch?’” “meeting topic: management strategy.” Examples of output from the AI include “relevance score: 0.92,” “relevance score: 0.15.” The analysis unit sorts the questions in the analysis queue by high relevance score and prioritizes analysis of highly relevant questions. In subsequent processing, the posting unit may prioritize the display of highly relevant answers or postpone those with low relevance. When not using AI, it is also possible to determine relevance using keyword matching or tag matching. As a technical effect, the analysis unit realizes relevance-focused control of analysis order tailored to meeting content and progress, improving meeting progress efficiency, optimizing information transmission, and enhancing user satisfaction, thereby improving computer technology itself. Specific application fields include priority response to agenda items in project meetings in companies, Q&A linked to lesson content in educational settings, department-specific interview support in medical settings, and field-specific resident support in government agencies.

The posting unit can estimate the user's emotion and adjust the timing of posting based on the estimated emotion of the user. For example, the posting unit estimates the user's emotion and adjusts the timing of posting based on the estimated emotion. For instance, if the user is nervous, the generative AI delays the posting timing to allow time for relaxation. If the user is excited, the generative AI posts immediately to respond quickly. If the user is fatigued, the generative AI adjusts the posting timing to encourage a break. By adjusting the posting timing according to the user's emotion, posting can be performed at a more appropriate timing. Emotion estimation is realized using an emotion estimation function, such as an emotion engine or generative AI. The generative AI may be, for example, a text generation AI (such as an LLM) or a multimodal generative AI, but is not limited to these examples. Some or all of the above-described processing in the posting unit may be performed using generative AI, or may be performed without using generative AI. For example, the posting unit may use generative AI to estimate the user's emotion and adjust the timing of posting. Specifically, the posting unit simultaneously acquires multimodal data such as the user's voice input (e.g., 16 kHz sampled 1D waveform array), facial expression image (224×224 pixel RGB image), and utterance text (subword token ID sequence), and inputs them into an emotion estimation engine (an ensemble model of voice emotion recognition CNN, facial expression recognition CNN, and text emotion classification BERT). The emotion estimation engine extracts features for each modality, integrates them as high-dimensional vectors, and outputs emotion labels (nervousness, excitement, fatigue, relaxation, etc.) and their probability distributions (e.g., nervousness 0.7, excitement 0.2, fatigue 0.1). Examples of AI input include “voice waveform with trembling voice,” “smiling face image,” and utterance text such as “I'm a little nervous now.” Examples of AI output include score vectors such as “nervousness: 0.75,” “excitement: 0.15,” “fatigue: 0.1,” or labels such as “current emotion: nervousness.” The posting unit applies a posting timing control algorithm (e.g., delay 5 seconds if nervousness is 0.6 or higher, immediate posting if excitement is 0.7 or higher, break suggestion if fatigue is 0.5 or higher) based on the emotion estimation result to dynamically determine the posting timing. In subsequent processing, the posting timing control signal is sent to the chat system API to control the actual posting timing. If AI is not used, simple threshold judgment based on voice volume or utterance interval can also be used for timing adjustment. As a technical effect, the posting unit realizes flexible posting timing adjustment according to the user's psychological state and situation, compared to conventional uniform posting timing control, thereby improving user experience, optimizing information transmission, and facilitating meeting progress, which leads to improvements in computer technology itself. Specific application fields include stress management posting in corporate online meetings, student psychology-aware posting in educational settings, patient psychology-aware information sharing in medical settings, and speech promotion posting in resident briefing sessions at government agencies.

The posting unit can adjust the level of detail of posting at the time of posting based on the importance of the answer. For example, the posting unit adjusts the level of detail of posting at the time of posting based on the importance of the answer. For instance, for highly important answers, the generative AI performs detailed posting. For less important answers, the generative AI performs concise posting. Additionally, the generative AI adjusts the posting priority according to the importance of the answer. By adjusting the level of detail of posting based on the importance of the answer, more appropriate posting can be performed. Some or all of the above-described processing in the posting unit may be performed using generative AI, or may be performed without using generative AI. For example, the posting unit may use generative AI to adjust the level of detail of posting based on the importance of the answer. Specifically, the posting unit receives answer data from the analysis unit (structured data including answer text, importance score, related links, etc.) as input and applies a posting detail control algorithm according to the importance score (e.g., real values from 0.0 to 1.0). Examples of AI input include “Answer text: ‘This week's sales are 1 million yen.’ Importance: 0.95,” “Answer text: ‘Lunch is at 12 o'clock.’ Importance: 0.2,” and so on. The posting unit selects a detailed posting mode (e.g., adding supporting information, related document links, chart URLs, etc.) for high importance, and a concise posting mode (e.g., short posting with only key points) for low importance. Examples of AI output include, in detailed posting mode, “This week's sales are 1 million yen. For details, please refer to the sales management sheet for June 2024. Graph here→URL,” and in concise posting mode, “Lunch is at 12 o'clock.” In subsequent processing, the posting unit controls the display method in the chat field and notification priority according to the posting detail level. If AI is not used, posting detail control by simple conditional branching or template switching is also possible. As a technical effect, the posting unit realizes flexible posting detail control according to the importance of the answer, compared to conventional uniform posting detail, thereby optimizing information transmission, improving meeting progress efficiency, and enhancing user satisfaction, which leads to improvements in computer technology itself. Specific application fields include priority posting of important matters in companies, detailed posting of exam preparation answers in educational settings, information sharing with urgency assessment in medical settings, and priority posting of important agenda items in government agencies.

The posting unit can apply different posting algorithms at the time of posting according to the category of the answer. For example, the posting unit applies different posting algorithms at the time of posting according to the category of the answer. For instance, for technical answers, the generative AI applies a specialized posting algorithm. For business-related answers, the generative AI applies a business-oriented posting algorithm. For general answers, the generative AI applies a generic posting algorithm. By applying different posting algorithms according to the category of the answer, more appropriate posting can be performed. Some or all of the above-described processing in the posting unit may be performed using generative AI, or may be performed without using generative AI. For example, the posting unit may use generative AI to apply different posting algorithms according to the category of the answer. Specifically, the posting unit receives answer data from the analysis unit (structured data including answer text, category label, related links, etc.) as input and determines the category (e.g., “technical,” “business,” “general”) using a category classifier (such as a BERT-based sentence classification model). Examples of AI input include “Answer text: ‘The learning rate of the AI model is 0.001.’ Category: technical,” “Answer text: ‘This term's sales target is 20 million yen.’ Category: business,” “Answer text: ‘Lunch is at 12 o'clock.’ Category: general,” and so on. The posting unit applies different posting algorithms according to the category determination result, such as posting with technical term explanations and chart links for technical category, posting with decision support information and financial document links for business category, and concise posting with only summaries for general category. Examples of AI output include “Technical category: detailed explanation+chart URL,” “Business category: decision support information+document link,” “General category: summary only,” and so on. In subsequent processing, the posting unit controls the posting display method and notification priority for each category. If AI is not used, rule-based template switching or fixed posting for each category is also possible. As a technical effect, the posting unit realizes optimal posting algorithm selection according to the content of the answer, compared to conventional uniform posting processing, thereby improving response accuracy, ensuring expertise, and improving meeting progress efficiency, which leads to improvements in computer technology itself. Specific application fields include automatic posting in technical, management, and general meetings in companies, subject-specific answer posting in educational settings, department-specific information sharing in medical settings, and field-specific information provision in government agencies.

The posting unit can estimate the user's emotion and adjust the order of posting based on the estimated emotion of the user. For example, the posting unit estimates the user's emotion and adjusts the order of posting based on the estimated emotion. For instance, if the user is nervous, the generative AI prioritizes posting less important items to help the user relax. If the user is excited, the generative AI prioritizes posting more important items for quick response. If the user is fatigued, the generative AI prioritizes posting simpler items to reduce the burden. By adjusting the order of posting according to the user's emotion, posting can be performed in a more appropriate order. Emotion estimation is realized using an emotion estimation function, such as an emotion engine or generative AI. The generative AI may be, for example, a text generation AI (such as an LLM) or a multimodal generative AI, but is not limited to these examples. Some or all of the above-described processing in the posting unit may be performed using generative AI, or may be performed without using generative AI. For example, the posting unit may use generative AI to estimate the user's emotion and adjust the order of posting. Specifically, the posting unit inputs multimodal data such as the user's voice, facial expression image, and utterance text into an emotion estimation engine (an ensemble model of voice emotion recognition CNN, facial expression recognition CNN, and text emotion classification BERT), which outputs emotion labels (nervousness, excitement, fatigue, relaxation, etc.) and their probability distributions. Examples of AI input include “voice waveform with trembling voice,” “smiling face image,” and utterance text such as “I'm tired today.” Examples of emotion estimation engine output include score vectors such as “nervousness: 0.65,” “excitement: 0.2,” “fatigue: 0.1,” “relaxation: 0.05.” The posting unit inputs the emotion estimation result and the posting waiting list (including importance scores and difficulty labels for each posting) into a priority determination algorithm (weighted score calculation of emotional state×posting importance) to dynamically determine the posting order. For example, if nervousness is high, postings with lower difficulty are posted first; if excitement is high, postings with higher importance are prioritized; if fatigue is high, simpler postings are prioritized. Examples of output include “posting order list: Posting A→Posting C→Posting B” and “priority score for each posting.” In subsequent processing, postings are displayed in the posting UI with priority, and guidance is provided to make it easier for the user to select. If AI is not used, fixed order posting based on simple posting difficulty or importance labels is also possible. As a technical effect, the posting unit realizes posting order control according to the user's psychological state, thereby improving user experience, facilitating meeting progress, and reducing stress, which leads to improvements in computer technology itself. Specific application fields include speech support posting in corporate online meetings, guided posting for each student in educational settings, patient psychology-aware information sharing in medical settings, and speech promotion posting in resident briefing sessions at government agencies.

The posting unit can determine the posting priority at the time of posting based on the submission timing of the answer. For example, the posting unit determines the posting priority at the time of posting based on the submission timing of the answer. For instance, for recently submitted answers, the generative AI posts them with priority. For older answers, the generative AI posts them later. Additionally, the generative AI adjusts the posting priority according to the submission timing of the answer. By determining the posting priority based on the submission timing of the answer, posting can be performed in a more appropriate order. Some or all of the above-described processing in the posting unit may be performed using generative AI, or may be performed without using generative AI. For example, the posting unit may use generative AI to determine the posting priority based on the submission timing of the answer. Specifically, the posting unit receives answer data from the analysis unit (structured data including answer text, submission time, importance, etc.) as input, sorts the answers in the posting waiting queue by newest or chronological order based on the submission time (e.g., UNIX timestamp), and applies a priority determination algorithm (e.g., FIFO, LIFO, time-weighted priority calculation, etc.). Examples of AI input include “Answer text: ‘This week's sales are 1 million yen.’ Submission time: 1718000000,” “Answer text: ‘Last week's sales were 900,000 yen.’ Submission time: 1717000000,” and so on. Examples of AI output include “posting priority list: Answer A→Answer B” and “priority score for each answer.” The posting unit dynamically controls the allocation of posting resources and notification timing according to the submission timing, and posts answers that require real-time response with priority. In subsequent processing, the chat system API controls the posting order and notification timing. If AI is not used, simple chronological sorting or rule-based priority determination is also possible. As a technical effect, the posting unit realizes flexible priority control according to the submission timing of the answer, compared to conventional uniform posting order, thereby improving real-time performance, reducing response delay, and optimizing meeting progress, which leads to improvements in computer technology itself. Specific application fields include priority posting of new answers in corporate online meetings, real-time Q&A posting in educational settings, information sharing with urgency assessment in medical settings, and automatic posting at resident service counters in government agencies.

The posting unit can adjust the order of posting at the time of posting based on the relevance of the answer. For example, the posting unit adjusts the order of posting at the time of posting based on the relevance of the answer. For instance, for highly relevant answers, the generative AI posts them with priority. For less relevant answers, the generative AI posts them later. Additionally, the generative AI adjusts the order of posting according to the relevance of the answer. By adjusting the order of posting based on the relevance of the answer, posting can be performed in a more appropriate order. Some or all of the above-described processing in the posting unit may be performed using generative AI, or may be performed without using generative AI. For example, the posting unit may use generative AI to adjust the order of posting based on the relevance of the answer. Specifically, the posting unit receives answer data from the analysis unit (structured data including answer text, related topic vector, relevance score, etc.) as input, calculates the semantic vector similarity (BERT-based cosine similarity calculation) between the answer text and the meeting agenda or ongoing project information (topic vector, project tag, etc.), and assigns a relevance score (0.0 to 1.0). Examples of AI input include “Answer text: ‘The learning rate of the AI model is 0.001.’ Meeting topic: AI development,” “Answer text: ‘Lunch is at 12 o'clock.’ Meeting topic: management strategy,” and so on. Examples of AI output include “relevance score: 0.92,” “relevance score: 0.15,” and so on. The posting unit sorts the answers in the posting waiting queue by high relevance score and posts highly relevant answers with priority. In subsequent processing, the chat system API can prioritize the display of highly relevant answers or delay the display of less relevant ones. If AI is not used, relevance determination by keyword matching or tag matching is also possible. As a technical effect, the posting unit realizes relevance-focused posting order control according to meeting content and progress, compared to conventional uniform posting order, thereby improving meeting progress efficiency, optimizing information transmission, and enhancing user satisfaction, which leads to improvements in computer technology itself. Specific application fields include agenda-priority posting in corporate project meetings, content-linked answer posting in educational settings, department-specific information sharing in medical settings, and field-specific resident response posting in government agencies.

The minutes creation unit can estimate the user's emotion and adjust the expression method of the minutes based on the estimated emotion of the user. For example, the minutes creation unit estimates the user's emotion and adjusts the expression method of the minutes based on the estimated emotion. For instance, if the user is nervous, the generative AI creates simple and easy-to-understand minutes. If the user is relaxed, the generative AI creates minutes with detailed explanations. If the user is excited, the generative AI creates visually appealing minutes. By adjusting the expression method of the minutes according to the user's emotion, more appropriate minutes can be created. Emotion estimation is realized using an emotion estimation function, such as an emotion engine or generative AI. The generative AI may be, for example, a text generation AI (such as an LLM) or a multimodal generative AI, but is not limited to these examples. Some or all of the above-described processing in the minutes creation unit may be performed using generative AI, or may be performed without using generative AI. For example, the minutes creation unit may use generative AI to estimate the user's emotion and adjust the expression method of the minutes. Specifically, the minutes creation unit simultaneously acquires multimodal data such as the user's voice input (16 kHz sampled 1D waveform array), facial expression image (224×224 pixel RGB image), and utterance text (subword token ID sequence), and inputs them into an emotion estimation engine (an ensemble model of voice emotion recognition CNN, facial expression recognition CNN, and text emotion classification BERT). The emotion estimation engine extracts features for each modality, integrates them as high-dimensional vectors, and outputs emotion labels (nervousness, relaxation, excitement, etc.) and their probability distributions (e.g., nervousness 0.7, relaxation 0.2, excitement 0.1). Examples of AI input include “voice waveform with trembling voice,” “smiling face image,” and utterance text such as “I'm relaxed today.” Examples of AI output include score vectors such as “nervousness: 0.75,” “relaxation: 0.15,” “excitement: 0.1,” or labels such as “current emotion: nervousness.” The minutes creation unit uses the emotion estimation result to provide output style control parameters (e.g., conciseness, detail, visual element insertion flag, etc.) to the minutes generation module (Transformer architecture with billions of parameters) for text generation. Examples of AI input include “Meeting content text: ‘10-minute discussion on agenda A.’ Emotion state: nervousness. Style control: concise,” and so on. Examples of AI output include “A concise discussion was held on agenda A” (concise mode), “A detailed explanation and exchange of opinions were held on agenda A. Comments from each speaker are also included” (detailed mode), and “The discussion content on agenda A is visualized with graphs and charts” (with visual elements). In subsequent processing, the minutes data is automatically saved to cloud storage or internal document management systems, and guidance or supplementary information according to the user's emotional state can be provided when sharing with all participants. If AI is not used, expression adjustment by template switching or rule-based style selection is also possible. As a technical effect, the minutes creation unit realizes flexible minutes expression control according to the user's psychological state and situation, compared to conventional uniform minutes generation, thereby improving user experience, optimizing information transmission, and enhancing the utilization of meeting records, which leads to improvements in computer technology itself. Specific application fields include minutes creation in corporate online meetings, explanation optimization for each student in educational settings, patient psychology-aware minutes in medical settings, and information provision in resident briefing sessions at government agencies.

The minutes creation unit can adjust the level of detail of the minutes at the time of minutes creation based on the importance of the meeting. For example, the minutes creation unit adjusts the level of detail of the minutes at the time of minutes creation based on the importance of the meeting. For instance, for highly important meetings, the generative AI creates detailed minutes. For less important meetings, the generative AI creates concise minutes. Additionally, the generative AI adjusts the priority of the minutes according to the importance of the meeting. By adjusting the level of detail of the minutes based on the importance of the meeting, more appropriate minutes can be created. Some or all of the above-described processing in the minutes creation unit may be performed using generative AI, or may be performed without using generative AI. For example, the minutes creation unit may use generative AI to adjust the level of detail of the minutes based on the importance of the meeting. Specifically, the minutes creation unit receives the importance score assigned to each meeting (e.g., real values from 0.0 to 1.0) and meeting content text (token ID sequence) as input. The minutes creation unit controls branching in the minutes generation pipeline according to the importance score, selecting a detailed minutes mode (e.g., full record of each speaker's utterances, presentation of discussion grounds, chart generation) for high importance, and a simple minutes mode (e.g., summary of key points, record of main decisions only) for low importance. Examples of AI input include “Meeting content text: ‘30-minute discussion on agenda A.’ Importance: 0.95,” “Meeting content text: ‘Adjustment of lunch time.’ Importance: 0.2,” and so on. Examples of AI output include, in detailed minutes mode, “Detailed record of each speaker's utterances and discussion grounds on agenda A. Related charts here→URL,” and in simple minutes mode, “Adjustment of lunch time was made.” The minutes creation unit dynamically allocates minutes generation resources (GPU computation time, number of external API calls, etc.) according to the importance score to optimize overall system computational efficiency and record quality. In subsequent processing, the minutes creation unit controls the saving method and notification priority according to the level of detail and importance of the minutes. If AI is not used, simple conditional branching or rule-based detail switching is also possible. As a technical effect, the minutes creation unit realizes flexible minutes detail control according to the importance of the meeting, compared to conventional uniform minutes generation, thereby optimizing the use of computational resources, improving record quality, and enhancing meeting management efficiency, which leads to improvements in computer technology itself. Specific application fields include recording of important meetings in companies, detailed records of exam preparation meetings in educational settings, minutes with urgency assessment in medical settings, and priority recording of important agenda items in government agencies.

The minutes creation unit can apply different minutes creation algorithms at the time of minutes creation according to the category of the meeting. For example, the minutes creation unit applies different minutes creation algorithms at the time of minutes creation according to the category of the meeting. For instance, for technical meetings, the generative AI applies a specialized minutes creation algorithm. For business-related meetings, the generative AI applies a business-oriented minutes creation algorithm. For general meetings, the generative AI applies a generic minutes creation algorithm. By applying different minutes creation algorithms according to the category of the meeting, more appropriate minutes can be created. Some or all of the above-described processing in the minutes creation unit may be performed using generative AI, or may be performed without using generative AI. For example, the minutes creation unit may use generative AI to apply different minutes creation algorithms according to the category of the meeting. Specifically, the minutes creation unit inputs meeting content text (token ID sequence) into a category classifier (BERT-based sentence classification model) to automatically determine category labels such as “technical,” “business,” or “general.” Examples of AI input include “Meeting content text: ‘Discussion on the learning rate of the AI model,’” “Meeting content text: ‘Discussion on this term's sales target,’” “Meeting content text: ‘Adjustment of lunch time,’” and so on. Examples of AI output include “Category: technical,” “Category: business,” “Category: general,” and so on. The minutes creation unit applies different minutes creation algorithms according to the category determination result, such as a minutes generation pipeline including technical term extraction, technical literature link addition, and formula generation for technical category; financial data summarization and decision support information addition for business category; and summary of key points only for general category. For example, for a technical meeting “Discussion on the learning rate of the AI model,” a specialized minutes is generated including the setting value and grounds for the learning rate and related technical literature URLs; for a business meeting “Discussion on this term's sales target,” a minutes is generated including the sales target value, decision reasons, and related document links. In subsequent processing, the minutes creation unit controls the saving format and notification method for each category. If AI is not used, minutes generation by rule-based keyword matching or template switching for each category is also possible. As a technical effect, the minutes creation unit realizes optimal minutes creation algorithm selection according to meeting content, compared to conventional uniform minutes generation, thereby improving recording accuracy, ensuring expertise, and enhancing meeting management efficiency, which leads to improvements in computer technology itself. Specific application fields include automatic minutes creation for technical, management, and general meetings in companies, subject-specific minutes in educational settings, department-specific records in medical settings, and field-specific meeting records in government agencies.

The minutes creation unit can estimate the user's emotion and adjust the length of the minutes based on the estimated emotion of the user. For example, the minutes creation unit estimates the user's emotion and adjusts the length of the minutes based on the estimated emotion. For instance, if the user is in a hurry, the generative AI creates short minutes that cover the key points. If the user is relaxed, the generative AI creates longer minutes with detailed explanations. If the user is excited, the generative AI creates visually appealing minutes. By adjusting the length of the minutes according to the user's emotion, more appropriate minutes can be created. Emotion estimation is realized using an emotion estimation function, such as an emotion engine or generative AI. The generative AI may be, for example, a text generation AI (such as an LLM) or a multimodal generative AI, but is not limited to these examples. Some or all of the above-described processing in the minutes creation unit may be performed using generative AI, or may be performed without using generative AI. For example, the minutes creation unit may use generative AI to estimate the user's emotion and adjust the length of the minutes. Specifically, the minutes creation unit inputs multimodal data such as the user's voice, facial expression image, and utterance text into an emotion estimation engine (an ensemble model of voice emotion recognition CNN, facial expression recognition CNN, and text emotion classification BERT), which outputs emotion labels (e.g., in a hurry, relaxed, excited) and their probability distributions. Examples of AI input include “fast-talking voice waveform,” “calm facial expression image,” and utterance text such as “I'm in a hurry.” Examples of emotion estimation engine output include score vectors such as “in a hurry: 0.8,” “relaxed: 0.15,” “excited: 0.05.” The minutes creation unit uses the emotion estimation result to provide output length control parameters (e.g., maximum token count, detail flag, visual element insertion flag, etc.) to the minutes generation module (large language model) for text generation. Examples of AI input include “Meeting content text: ‘Progress report for this week.’ Emotion state: in a hurry. Output length: short,” and so on. Examples of AI output include “Progress for this week is 50%.” (short mode), “Progress for this week is 50%. For details, please refer to the project management sheet.” (long mode), “Progress for this week is 50%. Graph here→URL” (with visual elements). In subsequent processing, the minutes creation unit controls the saving method and notification priority according to the length and expression of the minutes. If AI is not used, minutes generation by template switching or rule-based output length control is also possible. As a technical effect, the minutes creation unit realizes flexible minutes length control according to the user's psychological state and situation, compared to conventional uniform minutes length, thereby improving user experience, optimizing information transmission, and enhancing the utilization of meeting records, which leads to improvements in computer technology itself. Specific application fields include instant recording in corporate online meetings, explanation optimization for each student in educational settings, patient psychology-aware minutes in medical settings, and information provision in resident briefing sessions at government agencies.

The minutes creation unit can determine the priority of minutes creation at the time of minutes creation based on the submission timing of the meeting. For example, the minutes creation unit determines the priority of minutes creation at the time of minutes creation based on the submission timing of the meeting. For instance, for recently held meetings, the generative AI creates minutes with priority. For older meetings, the generative AI creates minutes later. Additionally, the generative AI adjusts the priority of minutes creation according to the submission timing of the meeting. By determining the priority of minutes creation based on the submission timing of the meeting, minutes can be created in a more appropriate order. Some or all of the above-described processing in the minutes creation unit may be performed using generative AI, or may be performed without using generative AI. For example, the minutes creation unit may use generative AI to determine the priority of minutes creation based on the submission timing of the meeting. Specifically, the minutes creation unit receives the submission time assigned to each meeting (e.g., UNIX timestamp) and meeting content text (token ID sequence) as input. The minutes creation unit sorts the meetings in the minutes creation waiting queue by newest or chronological order based on the submission time and applies a priority determination algorithm (e.g., FIFO, LIFO, time-weighted priority calculation, etc.). Examples of AI input include “Meeting content text: ‘Progress report for this week.’ Submission time: 1718000000,” “Meeting content text: ‘Progress report for last week.’ Submission time: 1717000000,” and so on. Examples of AI output include “minutes creation priority list: Meeting A→Meeting B” and “priority score for each meeting.” The minutes creation unit dynamically controls the allocation of minutes generation resources and notification timing according to the submission timing, and records meetings that require real-time response with priority. In subsequent processing, the minutes creation unit controls the order of minutes creation and notification timing. If AI is not used, simple chronological sorting or rule-based priority determination is also possible. As a technical effect, the minutes creation unit realizes flexible priority control according to the submission timing of the meeting, compared to conventional uniform minutes creation order, thereby improving real-time performance, reducing recording delay, and optimizing meeting management, which leads to improvements in computer technology itself. Specific application fields include priority recording of new meetings in corporate online meetings, real-time minutes creation in educational settings, minutes with urgency assessment in medical settings, and automatic recording at resident service counters in government agencies.

The minutes creation unit can adjust the order of minutes creation at the time of minutes creation based on the relevance of the meeting. For example, the minutes creation unit adjusts the order of minutes creation at the time of minutes creation based on the relevance of the meeting. For instance, for highly relevant meetings, the generative AI creates minutes with priority. For less relevant meetings, the generative AI creates minutes later. Additionally, the generative AI adjusts the order of minutes creation according to the relevance of the meeting. By adjusting the order of minutes creation based on the relevance of the meeting, minutes can be created in a more appropriate order. Some or all of the above-described processing in the minutes creation unit may be performed using generative AI, or may be performed without using generative AI. For example, the minutes creation unit may use generative AI to adjust the order of minutes creation based on the relevance of the meeting. Specifically, the minutes creation unit receives meeting content text (token ID sequence) and meeting agenda or ongoing project information (topic vector, project tag, etc.) as input. The minutes creation unit calculates the semantic vector similarity (BERT-based cosine similarity calculation) between the meeting content and the project/agenda, and assigns a relevance score (0.0 to 1.0). Examples of AI input include “Meeting content text: ‘Progress of AI development project.’ Project tag: AI development,” “Meeting content text: ‘Adjustment of lunch time.’ Project tag: management strategy,” and so on. Examples of AI output include “relevance score: 0.92,” “relevance score: 0.15,” and so on. The minutes creation unit sorts the meetings in the minutes creation waiting queue by high relevance score and records highly relevant meetings with priority. In subsequent processing, highly relevant minutes can be prioritized for display, while less relevant ones can be delayed. If AI is not used, relevance determination by keyword matching or tag matching is also possible. As a technical effect, the minutes creation unit realizes relevance-focused recording order control according to meeting content and progress, compared to conventional uniform minutes creation order, thereby improving meeting management efficiency, optimizing information transmission, and enhancing user satisfaction, which leads to improvements in computer technology itself. Specific application fields include agenda-priority recording in corporate project meetings, content-linked minutes in educational settings, department-specific records in medical settings, and field-specific resident response records in government agencies.

The proposal unit can estimate the user's emotion and adjust the proposal method of next actions based on the estimated emotion of the user. For example, the proposal unit estimates the user's emotion and adjusts the proposal method of next actions based on the estimated emotion. For instance, if the user is nervous, the generative AI proposes simple and easy-to-understand next actions. If the user is relaxed, the generative AI proposes next actions with detailed explanations. If the user is excited, the generative AI proposes visually appealing next actions. By adjusting the proposal method of next actions according to the user's emotion, more appropriate proposals can be made. Emotion estimation is realized using an emotion estimation function, such as an emotion engine or generative AI. The generative AI may be, for example, a text generation AI (such as an LLM) or a multimodal generative AI, but is not limited to these examples. Some or all of the above-described processing in the proposal unit may be performed using generative AI, or may be performed without using generative AI. For example, the proposal unit may use generative AI to estimate the user's emotion and adjust the proposal method of next actions. Specifically, the proposal unit simultaneously acquires multimodal data such as the user's voice input (16 kHz sampled 1D waveform array), facial expression image (224×224 pixel RGB image), and utterance text (subword token ID sequence), and inputs them into an emotion estimation engine (an ensemble model of voice emotion recognition CNN, facial expression recognition CNN, and text emotion classification BERT). The emotion estimation engine extracts features for each modality, integrates them as high-dimensional vectors, and outputs emotion labels (nervousness, relaxation, excitement, etc.) and their probability distributions (e.g., nervousness 0.7, relaxation 0.2, excitement 0.1). Examples of AI input include “voice waveform with trembling voice,” “smiling face image,” and utterance text such as “I'm relaxed today.” Examples of AI output include score vectors such as “nervousness: 0.75,” “relaxation: 0.15,” “excitement: 0.1,” or labels such as “current emotion: nervousness.” The proposal unit uses the emotion estimation result to provide output style control parameters (e.g., conciseness, detail, visual element insertion flag, etc.) to the next action proposal generation module (Transformer architecture with billions of parameters) for text generation. Examples of AI input include “Unresolved issue: ‘Issue B is unresolved.’ Emotion state: nervousness. Style control: concise,” and so on. Examples of AI output include “Let's discuss issue B at the next meeting” (concise mode), “Let's prioritize issue B at the next meeting and consider solutions. For details, please refer to the minutes” (detailed mode), and “Let's visualize the progress of issue B with a graph and share it at the next meeting” (with visual elements). The proposal unit automatically inserts the proposal content into the chat field or minutes and notifies participants. If AI is not used, proposal method adjustment by template switching or rule-based style selection is also possible. As a technical effect, the proposal unit realizes flexible proposal expression control according to the user's psychological state and situation, compared to conventional uniform proposal generation, thereby improving user experience, optimizing behavioral guidance, and enhancing the accuracy of post-meeting task execution, which leads to improvements in computer technology itself. Specific application fields include action proposals in corporate project management, student-specific issue proposals in educational settings, patient psychology-aware treatment proposals in medical settings, and behavioral proposals in resident briefing sessions at government agencies.

The proposal unit can adjust the level of detail of proposals at the time of next action proposal based on the importance of the meeting. For example, the proposal unit adjusts the level of detail of proposals at the time of next action proposal based on the importance of the meeting. For instance, for highly important meetings, the generative AI proposes detailed next actions. For less important meetings, the generative AI proposes concise next actions. Additionally, the generative AI adjusts the priority of next actions according to the importance of the meeting. By adjusting the level of detail of proposals based on the importance of the meeting, more appropriate proposals can be made. Some or all of the above-described processing in the proposal unit may be performed using generative AI, or may be performed without using generative AI. For example, the proposal unit may use generative AI to adjust the level of detail of proposals based on the importance of the meeting. Specifically, the proposal unit receives the importance score assigned to each meeting (e.g., real values from 0.0 to 1.0), meeting content text (token ID sequence), and unresolved issue list as input. The proposal unit controls branching in the proposal generation pipeline according to the importance score, selecting a detailed proposal mode (e.g., background explanation of the issue, presentation of grounds, related document links, multiple action candidates) for high importance, and a simple proposal mode (e.g., short proposal with only key points) for low importance. Examples of AI input include “Meeting content text: ‘30-minute discussion on agenda A.’ Importance: 0.95. Unresolved issue: ‘Issue B,’” and so on. Examples of AI output include, in detailed proposal mode, “For issue B, let's prioritize discussion at the next meeting and consider solutions. Grounds: Minutes for June 2024, related documents here→URL. Additional action candidates: expert hearing, update of progress management sheet,” and in simple proposal mode, “Let's discuss issue B at the next meeting.” The proposal unit dynamically allocates proposal generation resources (GPU computation time, number of external API calls, etc.) according to the importance score to optimize overall system computational efficiency and proposal quality. In subsequent processing, the proposal unit controls the notification method and saving method according to the level of detail and importance of the proposal. If AI is not used, proposal generation by simple conditional branching or rule-based detail switching is also possible. As a technical effect, the proposal unit realizes flexible proposal detail control according to the importance of the meeting, compared to conventional uniform proposal generation, thereby optimizing the use of computational resources, improving proposal quality, and enhancing meeting management efficiency, which leads to improvements in computer technology itself. Specific application fields include action proposals in important meetings in companies, exam preparation issue proposals in educational settings, treatment proposals with urgency assessment in medical settings, and priority proposals for important agenda items in government agencies.

The proposal unit can apply different proposal algorithms at the time of next action proposal according to the category of the meeting. For example, the proposal unit applies different proposal algorithms at the time of next action proposal according to the category of the meeting. For instance, for technical meetings, the generative AI applies a specialized proposal algorithm. For business-related meetings, the generative AI applies a business-oriented proposal algorithm. For general meetings, the generative AI applies a generic proposal algorithm. By applying different proposal algorithms according to the category of the meeting, more appropriate proposals can be made. Some or all of the above-described processing in the proposal unit may be performed using generative AI, or may be performed without using generative AI. For example, the proposal unit may use generative AI to apply different proposal algorithms according to the category of the meeting. Specifically, the proposal unit inputs meeting content text (token ID sequence) into a category classifier (BERT-based sentence classification model) to automatically determine category labels such as “technical,” “business,” or “general.” Examples of AI input include “Meeting content text: ‘Discussion on the learning rate of the AI model,’” “Meeting content text: ‘Discussion on this term's sales target,’” “Meeting content text: ‘Adjustment of lunch time,’” and so on. Examples of AI output include “Category: technical,” “Category: business,” “Category: general,” and so on. The proposal unit applies different proposal algorithms according to the category determination result, such as a proposal generation pipeline including technical term extraction, technical literature link addition, and formula generation for technical category; financial data summarization and decision support information addition for business category; and summary of key points only for general category. For example, for a technical meeting “Discussion on the learning rate of the AI model,” a specialized proposal is generated including the setting value and grounds for the learning rate and related technical literature URLs; for a business meeting “Discussion on this term's sales target,” a proposal is generated including the sales target value, decision reasons, and related document links. In subsequent processing, the proposal unit controls the saving format and notification method for each category. If AI is not used, proposal generation by rule-based keyword matching or template switching for each category is also possible. As a technical effect, the proposal unit realizes optimal proposal algorithm selection according to meeting content, compared to conventional uniform proposal generation, thereby improving proposal accuracy, ensuring expertise, and enhancing meeting management efficiency, which leads to improvements in computer technology itself. Specific application fields include automatic action proposals for technical, management, and general meetings in companies, subject-specific issue proposals in educational settings, department-specific treatment proposals in medical settings, and field-specific business proposals in government agencies.

The proposal unit can estimate the user's emotion and determine the priority of next actions based on the estimated emotion of the user. For example, the proposal unit estimates the user's emotion and determines the priority of next actions based on the estimated emotion. For instance, if the user is nervous, the generative AI prioritizes proposing less important next actions to help the user relax. If the user is excited, the generative AI prioritizes proposing more important next actions for quick response. If the user is fatigued, the generative AI prioritizes proposing simpler next actions to reduce the burden. By determining the priority of next actions according to the user's emotion, more appropriate proposals can be made. Emotion estimation is realized using an emotion estimation function, such as an emotion engine or generative AI. The generative AI may be, for example, a text generation AI (such as an LLM) or a multimodal generative AI, but is not limited to these examples. Some or all of the above-described processing in the proposal unit may be performed using generative AI, or may be performed without using generative AI. For example, the proposal unit may use generative AI to estimate the user's emotion and determine the priority of next actions. Specifically, the proposal unit inputs multimodal data such as the user's voice, facial expression image, and utterance text into an emotion estimation engine (an ensemble model of voice emotion recognition CNN, facial expression recognition CNN, and text emotion classification BERT), which outputs emotion labels (nervousness, excitement, fatigue, relaxation, etc.) and their probability distributions. Examples of AI input include “voice waveform with trembling voice,” “smiling face image,” and utterance text such as “I'm tired today.” Examples of emotion estimation engine output include score vectors such as “nervousness: 0.65,” “excitement: 0.2,” “fatigue: 0.1,” “relaxation: 0.05.” The proposal unit inputs the emotion estimation result and the unresolved issue list (including importance scores and difficulty labels for each issue) into a priority determination algorithm (weighted score calculation of emotional state×issue importance) to dynamically determine the proposal order. For example, if nervousness is high, next actions with lower difficulty are proposed first; if excitement is high, next actions with higher importance are prioritized; if fatigue is high, simpler next actions are prioritized. Examples of output include “proposal order list: nextActionA→nextActionC→nextActionB” and “priority score for each nextAction.” In subsequent processing, next actions are displayed in the proposal UI with priority, and guidance is provided to make it easier for the user to select. If AI is not used, fixed order proposal based on simple issue difficulty or importance labels is also possible. As a technical effect, the proposal unit realizes next action proposal order control according to the user's psychological state, thereby improving user experience, facilitating meeting progress, and reducing stress, which leads to improvements in computer technology itself. Specific application fields include speech support proposals in corporate online meetings, guided issue proposals for each student in educational settings, patient psychology-aware treatment proposals in medical settings, and behavioral proposals in resident briefing sessions at government agencies.

The proposal unit can determine the priority of proposals at the time of next action proposal based on the submission timing of the meeting. For example, the proposal unit determines the priority of proposals at the time of next action proposal based on the submission timing of the meeting. For instance, for recently held meetings, the generative AI proposes next actions with priority. For older meetings, the generative AI proposes next actions later. Additionally, the generative AI adjusts the priority of proposals according to the submission timing of the meeting. By determining the priority of proposals based on the submission timing of the meeting, more appropriate proposals can be made. Some or all of the above-described processing in the proposal unit may be performed using generative AI, or may be performed without using generative AI. For example, the proposal unit may use generative AI to determine the priority of proposals based on the submission timing of the meeting. Specifically, the proposal unit receives the submission time assigned to each meeting (e.g., UNIX timestamp), meeting content text (token ID sequence), and unresolved issue list as input. The proposal unit sorts the meetings in the proposal waiting queue by newest or chronological order based on the submission time and applies a priority determination algorithm (e.g., FIFO, LIFO, time-weighted priority calculation, etc.). Examples of AI input include “Meeting content text: ‘Progress report for this week.’ Submission time: 1718000000. Unresolved issue: ‘Issue B,’” and so on. Examples of AI output include “proposal priority list: Meeting A→Meeting B” and “priority score for each meeting.” The proposal unit dynamically controls the allocation of proposal generation resources and notification timing according to the submission timing, and proposes next actions for meetings that require real-time response with priority. In subsequent processing, the proposal unit controls the order of proposals and notification timing. If AI is not used, simple chronological sorting or rule-based priority determination is also possible. As a technical effect, the proposal unit realizes flexible priority control according to the submission timing of the meeting, compared to conventional uniform proposal order, thereby improving real-time performance, reducing proposal delay, and optimizing meeting management, which leads to improvements in computer technology itself. Specific application fields include priority proposals for new issues in corporate online meetings, real-time issue proposals in educational settings, treatment proposals with urgency assessment in medical settings, and automatic proposals at resident service counters in government agencies.

The proposal unit can adjust the order of proposals at the time of next action proposal based on the relevance of the meeting. For example, the proposal unit adjusts the order of proposals at the time of next action proposal based on the relevance of the meeting. For instance, for highly relevant meetings, the generative AI proposes next actions with priority. For less relevant meetings, the generative AI proposes next actions later. Additionally, the generative AI adjusts the order of proposals according to the relevance of the meeting. By adjusting the order of proposals based on the relevance of the meeting, more appropriate proposals can be made. Some or all of the above-described processing in the proposal unit may be performed using generative AI, or may be performed without using generative AI. For example, the proposal unit may use generative AI to adjust the order of proposals based on the relevance of the meeting. Specifically, the proposal unit receives meeting content text (token ID sequence), meeting agenda or ongoing project information (topic vector, project tag, etc.), and unresolved issue list as input. The proposal unit calculates the semantic vector similarity (BERT-based cosine similarity calculation) between the meeting content and the project/agenda, and assigns a relevance score (0.0 to 1.0). Examples of AI input include “Meeting content text: ‘Progress of AI development project.’ Project tag: AI development. Unresolved issue: ‘Issue B,’” and so on. Examples of AI output include “relevance score: 0.92,” “relevance score: 0.15,” and so on. The proposal unit sorts the meetings in the proposal waiting queue by high relevance score and proposes next actions for highly relevant meetings with priority. In subsequent processing, highly relevant proposals can be prioritized for display, while less relevant ones can be delayed. If AI is not used, relevance determination by keyword matching or tag matching is also possible. As a technical effect, the proposal unit realizes relevance-focused proposal order control according to meeting content and progress, compared to conventional uniform proposal order, thereby improving meeting management efficiency, optimizing information transmission, and enhancing user satisfaction, which leads to improvements in computer technology itself. Specific application fields include agenda-priority proposals in corporate project meetings, content-linked issue proposals in educational settings, department-specific treatment proposals in medical settings, and field-specific resident response proposals in government agencies.

The system according to the embodiment is not limited to the examples described above and can be variously modified, for example, as follows. Specifically, the system can realize a wide variety of variations from a technical perspective, such as AI model configuration for each unit, data flow, algorithm selection, input/output data format, user interface, hardware configuration, communication method, security control, and extension module linkage. For example, the system can replace the speech recognition engine in the receiving unit from a CNN-LSTM hybrid model to a Transformer-based end-to-end speech recognition model. In the analysis unit, inference by a single large language model can be extended to ensemble inference combining multiple specialized models (e.g., FAQ-specialized BERT, numerical calculation-specialized Transformer, image analysis-specialized CNN, etc.). In the posting unit, minutes creation unit, and proposal unit, the types of output control parameters (e.g., style, length, level of detail, visual element insertion flag, etc.) and output destinations (chat field, email, cloud storage, API linkage destination, etc.) can be flexibly switched. Furthermore, by adding user attribute information (position, field of expertise, past behavior history, etc.) and meeting metadata (meeting type, participant list, agenda tag, etc.) as input features for AI, more advanced personalization and adaptive control can be realized. Regarding AI model training methods, various techniques such as fine-tuning of pre-trained models, transfer learning, online learning, and reinforcement learning can be applied. From the perspective of data flow, optimal configuration can be selected according to system requirements and operating environment, such as real-time streaming processing, batch processing, edge device distributed processing, and cloud linkage processing. As a technical effect, the system brings improvements in computer technology itself, such as flexible configuration changes and scalability, enabling prompt response to diverse needs and operational constraints at the deployment site, and improving business efficiency, accuracy, user experience, optimization of computational resources, and security enhancement through AI utilization. Specific application fields include multi-location meeting systems for companies, individually optimized learning support in educational settings, medical record and treatment proposal in medical settings, automated resident response in government agencies, and on-site work support in manufacturing, enabling deployment to AI-utilizing meeting and information sharing systems in all fields.

The receiving unit can analyze the user's past meeting participation history and propose an optimal question receiving method. For example, based on the content and frequency of meetings the user has participated in in the past, the generative AI automatically proposes related questions. In addition, from the user's past meeting participation history, the generative AI selects the optimal question receiving method (such as voice or text). Furthermore, by analyzing the user's past meeting participation history, the generative AI proposes the optimal question receiving method for specific time periods. By analyzing the user's past meeting participation history, the optimal receiving method can be selected. Specifically, the receiving unit inputs meeting participation history data accumulated for each user (structured data including meeting ID, date and time, agenda, number of utterances, question content, receiving method, participation frequency, meeting type, etc.) into a history analysis engine. The history analysis engine combines time series feature extraction (e.g., LSTM or time series clustering), content feature extraction (e.g., BERT-based contextual embedding), and frequency analysis of receiving method labels to extract the user's question tendencies and optimal receiving channels as high-dimensional vectors. Examples of AI input include “Meeting history: 2024/06/01 technical meeting, 5 utterances, 2 questions, voice receiving,” “Meeting history: 2024/06/05 management meeting, 1 utterance, 0 questions, text receiving,” and so on. Examples of AI output include “Recommended receiving method: voice,” “Recommended receiving method: text,” “Related question list: ‘What is the learning rate of the AI model?’ ‘What is this term's sales target?’” as structured data. The receiving unit automatically displays the recommended receiving method in the user interface and provides guidance to make it easier for the user to select. Furthermore, algorithms for dynamically switching receiving methods for specific time periods (e.g., voice in the morning, text in the afternoon) or for each meeting type can also be applied. If AI is not used, simple history frequency aggregation or rule-based receiving method switching is also possible. As a technical effect, the receiving unit realizes optimization of receiving methods according to the user's past behavior patterns and meeting participation tendencies, thereby improving the convenience of question receiving, enhancing user satisfaction, improving meeting progress efficiency, and optimizing computational resources for the entire system, which leads to improvements in computer technology itself. Specific application fields include optimization of meeting receiving methods by position in companies, guided question receiving for each student in educational settings, expert meeting receiving support in medical settings, and question receiving by resident attribute in government agencies.

The analysis unit can generate answers to questions by taking into account the progress status of the user's current project. For example, based on the progress status of the project the user is currently working on, the generative AI generates optimal answers. Furthermore, depending on the progress status of the user's project, the generative AI provides relevant information. Additionally, by considering the progress status of the user's project, the generative AI proposes the next steps. In this way, by considering the progress status of the user's current project, more appropriate answers can be provided. Specifically, the analysis unit inputs project progress status data (e.g., progress rate, number of completed tasks, unresolved issues list, latest update date, project members, related document URLs, etc., as structured data) for the project currently handled by the user into a project progress analysis engine. The progress analysis engine vectorizes progress rates and task statuses, and extracts unresolved issues and past progress history as time-series features. Examples of AI input include: “Project name: AI Development”, “Progress rate: 65%”, “Unresolved issue: Issue B”, “Latest update: 2024/06/10”, “Question: ‘What should I do next?’”. Examples of AI output include: “Answer: Please start working on Issue B next”, “Related information: Details of Issue B are available at the project management sheet URL”, “Next step proposal: Recommend consulting an expert”, etc., as structured data. The analysis unit provides control parameters (e.g., progress threshold, priority issue flag, etc.) to the answer generation module (large language models or decision support AI) according to the project progress status, and generates optimal answers and next action proposals. In subsequent processing, the posting unit and proposal unit automatically post and record the answers and proposals in the chat field or minutes. If AI is not used, simple conditional branching based on progress rate or number of issues, or template-based answers are also possible. As a technical effect, the analysis unit realizes dynamic answer generation, information provision, and action proposals tailored to the user's project progress status, thereby improving business efficiency, supporting decision-making, optimizing project management, and enhancing the accuracy of information transmission, thus improving computer technology itself. Specific application fields include corporate project management support, progress-linked guidance in educational settings, progress-linked explanations in medical settings, and business progress management in government agencies.

The posting unit can analyze the user's past question history and select the optimal posting method. For example, based on the content of questions frequently asked by the user in the past, the generative AI automatically posts related answers. Additionally, from the user's past question history, the generative AI selects the optimal posting method (such as voice or text). Furthermore, by analyzing the user's past question history, the generative AI proposes the optimal posting method for specific time periods. In this way, by analyzing the user's past question history, the optimal posting method can be selected. Specifically, the posting unit inputs question history data accumulated for each user (e.g., question text, posting date and time, posting method, answer content, related meeting ID, posting success rate, etc., as structured data) into a history analysis engine. The history analysis engine combines topic classification of question content (contextual embedding based on BERT), frequency analysis of posting methods, and time-series analysis of posting success rates to extract the user's posting tendencies and optimal posting channels as high-dimensional vectors. Examples of AI input include: “Question history: 2024/06/01 ‘What is the learning rate of the AI model?’ Text posting”, “Question history: 2024/06/05 ‘What is this term's sales target?’ Voice posting”. Examples of AI output include: “Recommended posting method: voice”, “Recommended posting method: text”, “Related answer list: ‘The learning rate is 0.001’, ‘The sales target is 20 million yen’”, etc., as structured data. The posting unit automatically displays the recommended posting method on the user interface and provides guidance to facilitate user selection. Furthermore, algorithms for dynamically switching posting methods according to specific time periods or meeting types can also be applied. If AI is not used, simple frequency aggregation of history or rule-based switching of posting methods is also possible. As a technical effect, the posting unit realizes optimization of posting methods tailored to the user's past question tendencies and posting history, thereby improving posting efficiency, enhancing user satisfaction, streamlining meeting progress, and optimizing system-wide computational resources, thus improving computer technology itself. Specific application fields include role-based posting optimization in companies, student-guided posting in educational settings, expert meeting posting support in medical settings, and resident attribute-based posting support in government agencies.

The minutes creation unit can analyze the user's past meeting participation history and propose the optimal method for creating minutes. For example, based on the content and frequency of meetings the user has participated in previously, the generative AI automatically creates related minutes. Additionally, from the user's past meeting participation history, the generative AI selects the optimal minutes creation method (such as summary or detailed). Furthermore, by analyzing the user's past meeting participation history, the generative AI proposes the optimal minutes creation method for specific time periods. In this way, by analyzing the user's past meeting participation history, the optimal minutes creation method can be selected. Specifically, the minutes creation unit inputs meeting participation history data accumulated for each user (e.g., meeting ID, date and time, agenda, number of remarks, minutes creation method, meeting type, frequency of minutes usage, etc., as structured data) into a history analysis engine. The history analysis engine combines topic classification of meeting content (contextual embedding based on BERT), frequency analysis of minutes creation methods, and time-series analysis of minutes usage history to extract the user's minutes usage tendencies and optimal creation methods as high-dimensional vectors. Examples of AI input include: “Meeting history: 2024/06/01 Technical meeting, summary minutes used”, “Meeting history: 2024/06/05 Management meeting, detailed minutes used”. Examples of AI output include: “Recommended minutes creation method: summary”, “Recommended minutes creation method: detailed”, “Related minutes list: ‘Discussion on the learning rate of the AI model’, ‘Discussion on this term's sales target’”, etc., as structured data. The minutes creation unit automatically displays the recommended creation method on the user interface and provides guidance to facilitate user selection. Furthermore, algorithms for dynamically switching minutes creation methods according to specific time periods or meeting types can also be applied. If AI is not used, simple frequency aggregation of history or rule-based switching of creation methods is also possible. As a technical effect, the minutes creation unit realizes optimization of minutes creation methods tailored to the user's past meeting participation tendencies and minutes usage history, thereby improving recording efficiency, enhancing user satisfaction, streamlining meeting management, and optimizing system-wide computational resources, thus improving computer technology itself. Specific application fields include role-based minutes creation optimization in companies, student-guided minutes creation in educational settings, expert meeting record support in medical settings, and resident attribute-based minutes creation in government agencies.

The proposal unit can analyze the user's past meeting participation history and propose the optimal next actions. For example, based on the content and frequency of meetings the user has participated in previously, the generative AI automatically proposes related next actions. Additionally, from the user's past meeting participation history, the generative AI selects the optimal next actions. Furthermore, by analyzing the user's past meeting participation history, the generative AI proposes the optimal next actions for specific time periods. In this way, by analyzing the user's past meeting participation history, the optimal next actions can be selected. Specifically, the proposal unit inputs meeting participation history data accumulated for each user (e.g., meeting ID, date and time, agenda, number of remarks, unresolved issues list, history of executed next actions, meeting type, etc., as structured data) into a history analysis engine. The history analysis engine combines topic classification of meeting content (contextual embedding based on BERT), frequency analysis of unresolved issues, and time-series analysis of next action execution history to extract the user's behavioral tendencies and optimal action proposals as high-dimensional vectors. Examples of AI input include: “Meeting history: 2024/06/01 Technical meeting, unresolved issue B, executed next action A”, “Meeting history: 2024/06/05 Management meeting, unresolved issue C, executed next action B”. Examples of AI output include: “Recommended next action: Start working on issue B”, “Recommended next action: Report progress on issue C”, “Related action list: Consult an expert, update the progress management sheet”, etc., as structured data. The proposal unit automatically displays the recommended next actions on the user interface and provides guidance to facilitate user selection. Furthermore, algorithms for dynamically switching next actions according to specific time periods or meeting types can also be applied. If AI is not used, simple frequency aggregation of history or rule-based action proposals are also possible. As a technical effect, the proposal unit realizes optimization of next action proposals tailored to the user's past meeting participation tendencies and action execution history, thereby improving behavioral guidance efficiency, enhancing user satisfaction, streamlining meeting management, and optimizing system-wide computational resources, thus improving computer technology itself. Specific application fields include role-based action proposal optimization in companies, student-guided issue proposals in educational settings, expert meeting action support in medical settings, and resident attribute-based action proposals in government agencies.

The receiving unit can estimate the user's emotion and adjust the method of receiving questions based on the estimated emotion of the user. For example, if the user is nervous, the generative AI simplifies the method of receiving questions and provides time for relaxation. If the user is excited, the generative AI receives questions immediately and responds quickly. If the user is tired, the generative AI adjusts the method of receiving questions and encourages taking a break. In this way, by adjusting the method of receiving questions according to the user's emotion, questions can be received in a more appropriate manner. Specifically, the receiving unit simultaneously acquires multimodal data such as the user's voice input (1D waveform array sampled at 16 kHz), facial expression image (224×224 pixel RGB image), and utterance text (subword token ID sequence), and inputs them into an emotion estimation engine (ensemble model of voice emotion recognition CNN, facial expression recognition CNN, and text emotion classification BERT). The emotion estimation engine extracts features for each modality, integrates them as high-dimensional vectors, and outputs emotion labels (nervousness, excitement, fatigue, relaxation, etc.) and their probability distributions (e.g., nervousness 0.7, excitement 0.2, fatigue 0.1). Examples of AI input include: “Voice waveform with trembling”, “Smiling face image”, “Utterance text: ‘I'm a little nervous right now’”, etc. Examples of AI output include: “Nervousness: 0.75”, “Excitement: 0.15”, “Fatigue: 0.1”, as score vectors, or labels such as “Current emotion: nervousness”. Based on the emotion estimation results, the receiving unit applies a receiving method control algorithm (e.g., if nervousness is 0.6 or higher, only voice reception; if excitement is 0.7 or higher, immediate reception; if fatigue is 0.5 or higher, propose a break) and dynamically determines the receiving method. In subsequent processing, guidance on the receiving method or break proposals are automatically displayed on the receiving UI. If AI is not used, simple threshold judgments based on voice volume or utterance intervals can also be used to adjust the receiving method. As a technical effect, the receiving unit realizes flexible adjustment of the receiving method tailored to the user's psychological state and situation, compared to conventional uniform receiving method control, thereby improving user experience, optimizing information transmission, and facilitating smooth meeting progress, thus improving computer technology itself. Specific application fields include stress management reception in corporate online meetings, student psychological consideration reception in educational settings, patient psychological consideration question reception in medical settings, and speech promotion reception in resident briefings at government agencies.

The analysis unit can estimate the user's emotion and adjust the content of the answer based on the estimated emotion of the user. For example, if the user is nervous, the generative AI generates simple and easy-to-understand answers. If the user is relaxed, the generative AI generates answers that include detailed explanations. If the user is excited, the generative AI generates visually appealing answers. In this way, by adjusting the content of the answer according to the user's emotion, more appropriate answers can be provided. Specifically, the analysis unit simultaneously acquires multimodal data such as the user's voice input, facial expression image, and utterance text, and inputs them into an emotion estimation engine (ensemble model of voice emotion recognition CNN, facial expression recognition CNN, and text emotion classification BERT). The emotion estimation engine preprocesses the voice waveform (16 kHz sampling, 16,000 samples per second as a 1D array), face image (224×224 pixel RGB image), and utterance text (subword token ID sequence), and vectorizes them in the feature extraction layer. Examples of AI input include: “Voice waveform with trembling”, “Smiling face image”, “Utterance text: ‘I'm a little nervous’”, etc. The emotion estimation engine outputs emotion labels for each modality (e.g., nervousness, excitement, fatigue, relaxation) and their probability distributions (e.g., nervousness 0.7, excitement 0.1, fatigue 0.1, relaxation 0.1). Examples of output include: “Nervousness: 0.75”, “Relaxation: 0.15”, as score vectors, or labels such as “Current emotion: nervousness”. Based on the emotion estimation results, the analysis unit provides output style control parameters (e.g., conciseness, level of detail, visual element insertion flag, etc.) to the answer generation module (e.g., a Transformer architecture with billions of parameters) and performs text generation. Examples of AI input include: “Question: ‘What is the progress status of this project?’”, “Emotion state: nervousness”, “Style control: concise”, etc. Examples of AI output include: “Progress status is 50%” (concise mode), “The current progress status is 50%. Please refer to the project management sheet for details” (detailed mode), “Progress status is 50%. See the graph here→URL” (with visual elements). In subsequent processing, when the posting unit posts the answer text to the chat field, it is also possible to provide guidance or supplementary information according to the user's emotional state. If AI is not used, simple template switching or rule-based style selection can also be used for expression adjustment. As a technical effect, the analysis unit realizes flexible answer expression control tailored to the user's psychological state and situation, compared to conventional uniform answer generation, thereby improving user experience, optimizing information transmission, and facilitating smooth meeting progress, thus improving computer technology itself. Specific application fields include Q&A in corporate online meetings, explanation optimization for each student in educational settings, patient psychological consideration explanations in medical settings, and information provision in resident briefings at government agencies.

The posting unit can estimate the user's emotion and adjust the content of the posting based on the estimated emotion of the user. For example, if the user is nervous, the generative AI makes simple and easy-to-understand postings. If the user is relaxed, the generative AI makes postings that include detailed explanations. If the user is excited, the generative AI makes visually appealing postings. In this way, by adjusting the content of the posting according to the user's emotion, more appropriate postings can be made. Specifically, the posting unit simultaneously acquires multimodal data such as the user's voice input (1D waveform array sampled at 16 kHz), facial expression image (224×224 pixel RGB image), and utterance text (subword token ID sequence), and inputs them into an emotion estimation engine (ensemble model of voice emotion recognition CNN, facial expression recognition CNN, and text emotion classification BERT). The emotion estimation engine extracts features for each modality, integrates them as high-dimensional vectors, and outputs emotion labels (nervousness, excitement, fatigue, relaxation, etc.) and their probability distributions (e.g., nervousness 0.7, excitement 0.2, fatigue 0.1). Examples of AI input include: “Voice waveform with trembling”, “Smiling face image”, “Utterance text: ‘I'm a little nervous right now’”, etc. Examples of AI output include: “Nervousness: 0.75”, “Excitement: 0.15”, “Fatigue: 0.1”, as score vectors, or labels such as “Current emotion: nervousness”. Based on the emotion estimation results, the posting unit applies a posting content control algorithm (e.g., if nervousness is 0.6 or higher, concise posting; if excitement is 0.7 or higher, posting with visual elements; if relaxation is 0.5 or higher, detailed posting) and dynamically determines the posting content. In subsequent processing, guidance or supplementary information on the posting content is automatically displayed on the posting UI. If AI is not used, simple threshold judgments based on voice volume or utterance intervals can also be used to adjust the posting content. As a technical effect, the posting unit realizes flexible adjustment of posting content tailored to the user's psychological state and situation, compared to conventional uniform posting content control, thereby improving user experience, optimizing information transmission, and facilitating smooth meeting progress, thus improving computer technology itself. Specific application fields include stress management postings in corporate online meetings, student psychological consideration postings in educational settings, patient psychological consideration information sharing in medical settings, and speech promotion postings in resident briefings at government agencies.

The minutes creation unit can estimate the user's emotion and adjust the content of the minutes based on the estimated emotion of the user. For example, if the user is nervous, the generative AI creates simple and easy-to-understand minutes. If the user is relaxed, the generative AI creates minutes that include detailed explanations. If the user is excited, the generative AI creates visually appealing minutes. In this way, by adjusting the content of the minutes according to the user's emotion, more appropriate minutes can be created. Specifically, the minutes creation unit simultaneously acquires multimodal data such as the user's voice input (1D waveform array sampled at 16 kHz), facial expression image (224×224 pixel RGB image), and utterance text (subword token ID sequence), and inputs them into an emotion estimation engine (ensemble model of voice emotion recognition CNN, facial expression recognition CNN, and text emotion classification BERT). The emotion estimation engine extracts features for each modality, integrates them as high-dimensional vectors, and outputs emotion labels (nervousness, relaxation, excitement, etc.) and their probability distributions (e.g., nervousness 0.7, relaxation 0.2, excitement 0.1). Examples of AI input include: “Voice waveform with trembling”, “Smiling face image”, “Utterance text: ‘I'm relaxed today’”, etc. Examples of AI output include: “Nervousness: 0.75”, “Relaxation: 0.15”, “Excitement: 0.1”, as score vectors, or labels such as “Current emotion: nervousness”. Based on the emotion estimation results, the minutes creation unit provides output style control parameters (e.g., conciseness, level of detail, visual element insertion flag, etc.) to the minutes generation module (Transformer architecture with billions of parameters) and performs text generation. Examples of AI input include: “Meeting content text: ‘10-minute discussion on agenda A’”, “Emotion state: nervousness”, “Style control: concise”, etc. Examples of AI output include: “A concise discussion was held on agenda A” (concise mode), “A detailed explanation and exchange of opinions were conducted on agenda A. Comments from each speaker are also included” (detailed mode), “The discussion content on agenda A was visualized with graphs and charts” (with visual elements). In subsequent processing, the minutes data is automatically saved to cloud storage or internal document management systems, and when shared with all participants, guidance or supplementary information according to the user's emotional state can also be provided. If AI is not used, template switching or rule-based style selection can also be used for expression adjustment. As a technical effect, the minutes creation unit realizes flexible minutes expression control tailored to the user's psychological state and situation, compared to conventional uniform minutes generation, thereby improving user experience, optimizing information transmission, and enhancing the utilization of meeting records, thus improving computer technology itself. Specific application fields include minutes creation in corporate online meetings, explanation optimization for each student in educational settings, patient psychological consideration minutes in medical settings, and information provision in resident briefings at government agencies.

The proposal unit can estimate the user's emotion and adjust the content of the next actions based on the estimated emotion of the user. For example, if the user is nervous, the generative AI proposes simple and easy-to-understand next actions. If the user is relaxed, the generative AI proposes next actions that include detailed explanations. If the user is excited, the generative AI proposes visually appealing next actions. In this way, by adjusting the content of the next actions according to the user's emotion, more appropriate proposals can be made. Specifically, the proposal unit simultaneously acquires multimodal data such as the user's voice input (1D waveform array sampled at 16 kHz), facial expression image (224×224 pixel RGB image), and utterance text (subword token ID sequence), and inputs them into an emotion estimation engine (ensemble model of voice emotion recognition CNN, facial expression recognition CNN, and text emotion classification BERT). The emotion estimation engine extracts features for each modality, integrates them as high-dimensional vectors, and outputs emotion labels (nervousness, relaxation, excitement, etc.) and their probability distributions (e.g., nervousness 0.7, relaxation 0.2, excitement 0.1). Examples of AI input include: “Voice waveform with trembling”, “Smiling face image”, “Utterance text: ‘I'm relaxed today’”, etc. Examples of AI output include: “Nervousness: 0.75”, “Relaxation: 0.15”, “Excitement: 0.1”, as score vectors, or labels such as “Current emotion: nervousness”. Based on the emotion estimation results, the proposal unit provides output style control parameters (e.g., conciseness, level of detail, visual element insertion flag, etc.) to the next action proposal generation module (Transformer architecture with billions of parameters) and performs text generation. Examples of AI input include: “Unresolved issue: ‘Issue B is unresolved’”, “Emotion state: nervousness”, “Style control: concise”, etc. Examples of AI output include: “Let's discuss Issue B at the next meeting” (concise mode), “Let's prioritize discussing Issue B at the next meeting and consider solutions. Please refer to the minutes for details” (detailed mode), “Visualize the progress of Issue B with a graph and share it at the next meeting” (with visual elements). The proposal unit automatically inserts the proposal content into the chat field or minutes and notifies participants. If AI is not used, template switching or rule-based style selection can also be used to adjust the proposal method. As a technical effect, the proposal unit realizes flexible proposal expression control tailored to the user's psychological state and situation, compared to conventional uniform proposal generation, thereby improving user experience, optimizing behavioral guidance, and enhancing the accuracy of post-meeting task execution, thus improving computer technology itself. Specific application fields include action proposals in corporate project management, issue proposals for each student in educational settings, patient psychological consideration treatment proposals in medical settings, and behavioral proposals in resident briefings at government agencies.

Below, the processing flow of Example of the Embodiment is briefly described. Specifically, the present system automates and optimizes Q&A, information sharing, recording, and action proposals during meetings by having each module—receiving unit, analysis unit, posting unit, minutes creation unit, and proposal unit—work together to sequentially execute advanced data analysis, generation, and control using AI models. The system accepts various inputs at each step, such as voice, text, image, and structured data, and AI models (e.g., voice recognition CNN, context understanding BERT, generative large language models, emotion estimation ensemble models) perform feature extraction, semantic analysis, inference, generation, and control. Structured data such as token ID sequences, feature vectors, score distributions, category labels, and control parameters are exchanged between modules, and subsequent processing (e.g., priority determination, output length control, style adjustment, posting order decision, minutes saving, action proposal notification) is automatically executed. As a technical effect, the present system realizes high-precision, high-speed, and flexible information processing by AI compared to conventional manual meeting management, recording, and action management, thereby improving user experience, streamlining meeting progress, optimizing information transmission, recording, and behavioral guidance, and optimizing computational resource utilization, thus improving computer technology itself. Specific application fields include corporate online meetings, Q&A, recording, and issue proposals in educational settings, medical record and treatment proposals in medical settings, and resident briefings, minutes creation, and behavioral proposals in government agencies.

Step 1: The receiving unit receives questions by the user making an inquiry during a web conference. For example, when the user calls out “Hey, generative AI”, the receiving unit receives the question. The receiving unit analyzes the user's call using voice recognition technology and receives the question. Step 2: The analysis unit generates appropriate answers to questions based on pre-learned data. For example, the generative AI generates optimal answers to questions based on datasets of past questions and answers. The analysis unit uses generative AI to generate optimal answers to questions. Step 3: The posting unit posts the generated answers to the chat field. For example, by posting the answers generated by the generative AI to the chat field, all participants can check the answers. The posting unit uses generative AI to post the generated answers to the chat field. Step 4: The minutes creation unit summarizes the content of the meeting and outputs it as minutes. For example, the generative AI analyzes video data of the meeting and generates minutes. The minutes creation unit uses generative AI to summarize the content of the meeting and generate minutes. Step 5: The proposal unit analyzes the content of the meeting and proposes next actions for unresolved issues. For example, the generative AI analyzes the content of the meeting, identifies unresolved issues, and proposes next actions such as “Discuss this issue at the next meeting”. The proposal unit uses generative AI to analyze the content of the meeting and propose next actions for unresolved issues. Specifically, in Step 1, the system inputs the user's voice input (1D waveform array sampled at 16 kHz) into a voice recognition engine (Transformer-based voice recognition model) and extracts utterance text (subword token ID sequence). Examples of AI input include “Voice waveform: Hey, generative AI”, “Voice waveform: question text”, and examples of output include “Text: Hey, generative AI”, “Text: ‘What are this week's sales?’”. In Step 2, the analysis unit inputs the question text received from the receiving unit and meeting metadata (meeting ID, agenda, participant list, etc.) into a large language model and generates answer text, supporting information, related document links, etc. Examples of AI input include “Question text: ‘What are this week's sales?’”, “Meeting ID: 123”, “Agenda: Sales report”, and examples of output include “Answer: This week's sales are 1 million yen”, “Supporting information: Sales management sheet URL”. In Step 3, the posting unit inputs the answer text received from the analysis unit into a posting control module and determines the posting timing and display method for the chat field. Examples of AI input include “Answer text: This week's sales are 1 million yen”, “Posting priority: high”, and examples of output include “Posting timing: immediate”, “Display method: emphasis”. In Step 4, the minutes creation unit inputs meeting voice, text, and image data into a multimodal generative AI and generates summary minutes, detailed minutes, minutes with charts, etc. Examples of AI input include “Meeting voice data”, “Meeting text data”, “Meeting image data”, and examples of output include “Summary minutes: A concise discussion was held on agenda A”, “Detailed minutes: Detailed remarks by each speaker”. In Step 5, the proposal unit inputs the minutes and unresolved issues list into an action proposal generation AI and generates agenda proposals for the next meeting or issue resolution actions. Examples of AI input include “Unresolved issue: Issue B”, “Minutes: Discussion on agenda A”, and examples of output include “Proposal: Let's discuss Issue B at the next meeting”, “Proposal: Recommend consulting an expert”. The output of each step is linked as input to subsequent modules, and overall, the system realizes automation and optimization of meeting management, recording, and action management. As a technical effect, the present system realizes high-precision, high-speed, and flexible meeting management by AI through multi-stage analysis, generation, and control of voice, text, image, and structured data, compared to conventional manual work, thereby improving user experience, streamlining meeting progress, optimizing information transmission, recording, and behavioral guidance, and optimizing computational resource utilization, thus improving computer technology itself. Specific application fields include corporate online meetings, Q&A, recording, and issue proposals in educational settings, medical record and treatment proposals in medical settings, and resident briefings, minutes creation, and behavioral proposals in government agencies.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned receiving unit, analysis unit, posting unit, minutes creation unit, and proposal unit is implemented by at least one of, for example, a smart device 14 and a data processing apparatus 12. For example, the receiving unit is implemented by a microphone 38B and a control unit 46A of the smart device 14, and receives questions by analyzing a user's utterance using speech recognition technology. The analysis unit is implemented, for example, by a specific processing unit 290 of the data processing apparatus 12, and generates appropriate answers to questions based on pre-learned data. The posting unit is implemented, for example, by the control unit 46A of the smart device 14, and posts the generated answers to the chat field. The minutes creation unit is implemented, for example, by the specific processing unit 290 of the data processing apparatus 12, and summarizes the content of the meeting to generate minutes. The proposal unit is implemented, for example, by the specific processing unit 290 of the data processing apparatus 12, and analyzes the content of the meeting to propose next actions for unresolved issues. The correspondence between each unit and the apparatus or control unit is not limited to the above examples, and various modifications are possible.

### Second Embodiment

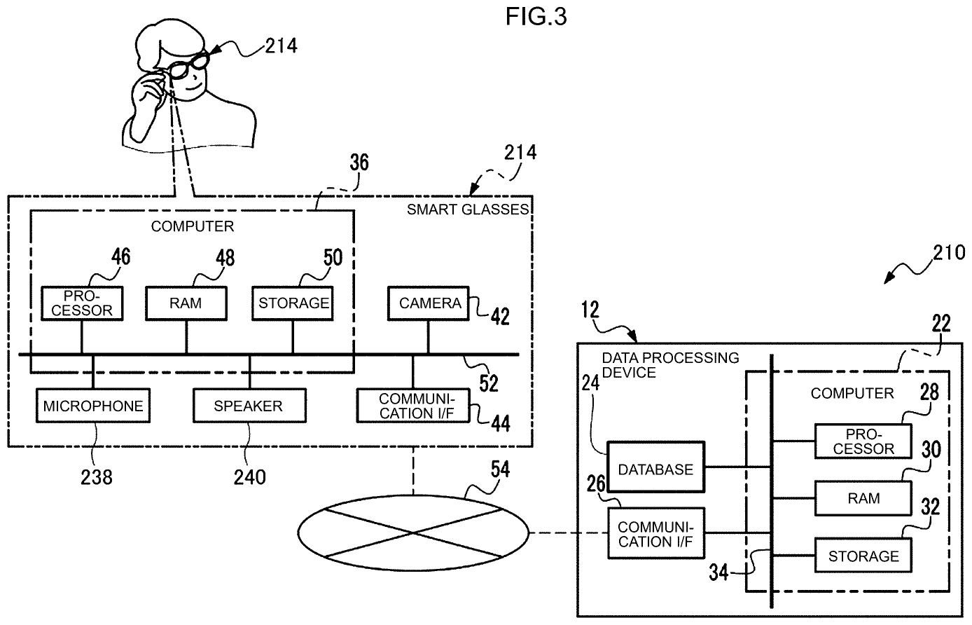

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

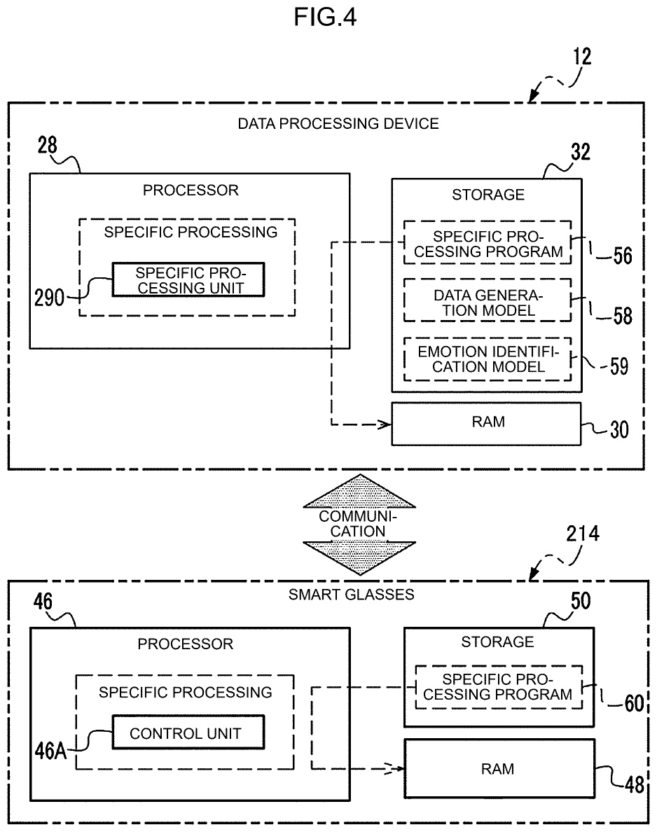

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned receiving unit, analysis unit, posting unit, minutes creation unit, and proposal unit is implemented by at least one of, for example, smart glasses 214 and a data processing apparatus 12. For example, the receiving unit is implemented by a microphone 238 and a control unit 46A of the smart glasses 214, and receives questions by analyzing a user's utterance using speech recognition technology. The analysis unit is implemented, for example, by a specific processing unit 290 of the data processing apparatus 12, and generates appropriate answers to questions based on pre-learned data. The posting unit is implemented, for example, by the control unit 46A of the smart glasses 214, and posts the generated answers to the chat field. The minutes creation unit is implemented, for example, by the specific processing unit 290 of the data processing apparatus 12, and summarizes the content of the meeting to generate minutes. The proposal unit is implemented, for example, by the specific processing unit 290 of the data processing apparatus 12, and analyzes the content of the meeting to propose next actions for unresolved issues. The correspondence between each unit and the apparatus or control unit is not limited to the above examples, and various modifications are possible.

### Third Embodiment

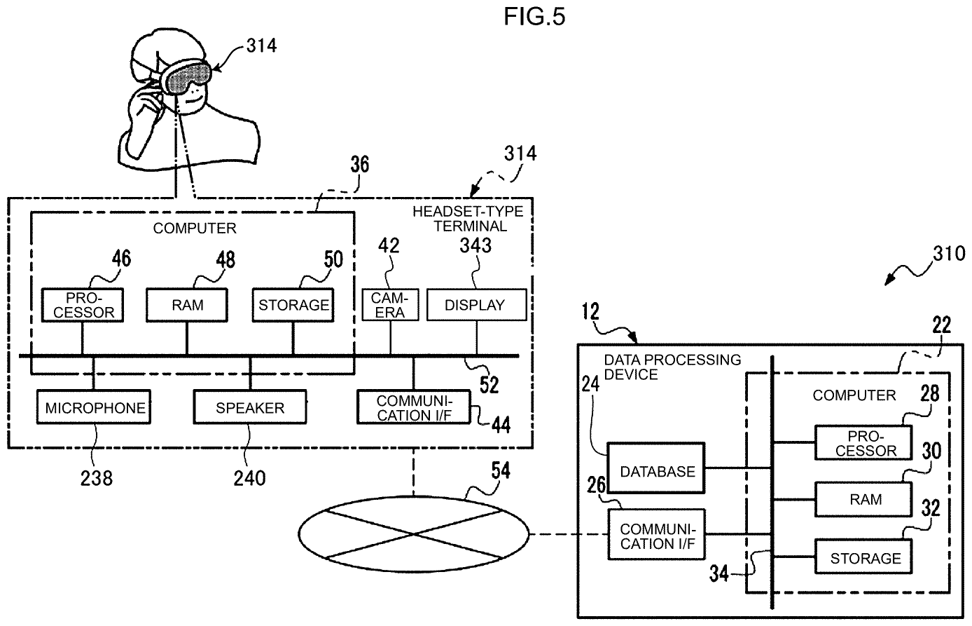

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

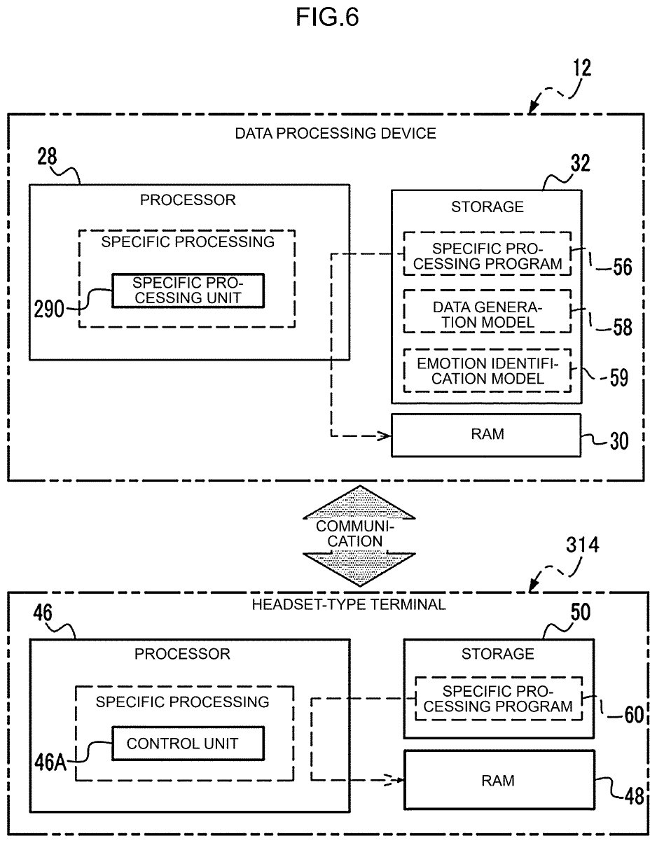

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned receiving unit, analysis unit, posting unit, minutes creation unit, and proposal unit is implemented by at least one of, for example, a headset-type terminal 314 and a data processing apparatus 12. For example, the receiving unit is implemented by a microphone 238 and a control unit 46A of the headset-type terminal 314, and receives questions by analyzing a user's utterance using speech recognition technology. The analysis unit is implemented, for example, by a specific processing unit 290 of the data processing apparatus 12, and generates appropriate answers to questions based on pre-learned data. The posting unit is implemented, for example, by the control unit 46A of the headset-type terminal 314, and posts the generated answers to the chat field. The minutes creation unit is implemented, for example, by the specific processing unit 290 of the data processing apparatus 12, and summarizes the content of the meeting to generate minutes. The proposal unit is implemented, for example, by the specific processing unit 290 of the data processing apparatus 12, and analyzes the content of the meeting to propose next actions for unresolved issues. The correspondence between each unit and the apparatus or control unit is not limited to the above examples, and various modifications are possible.

### Fourth Embodiment

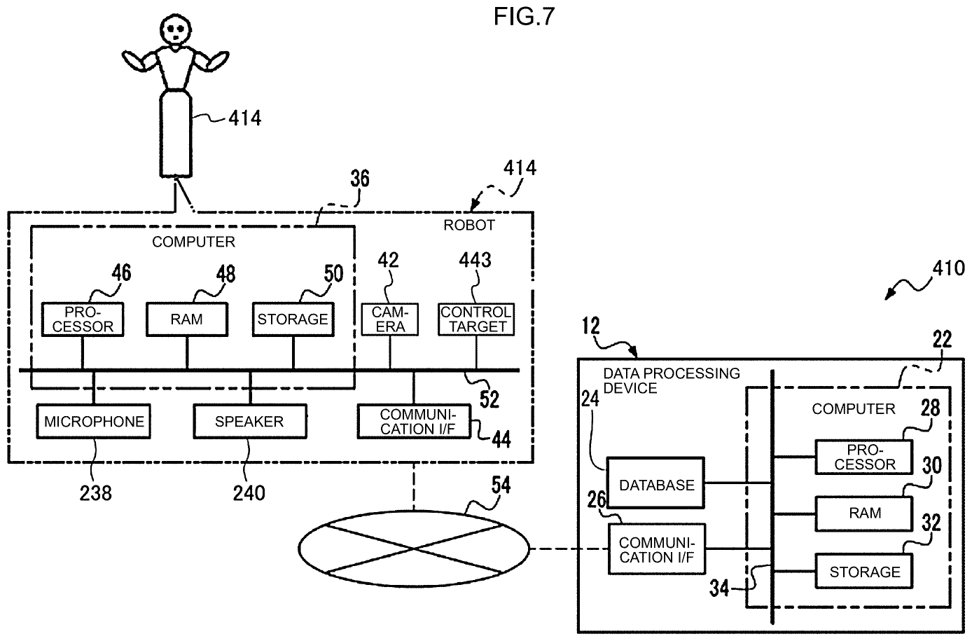

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

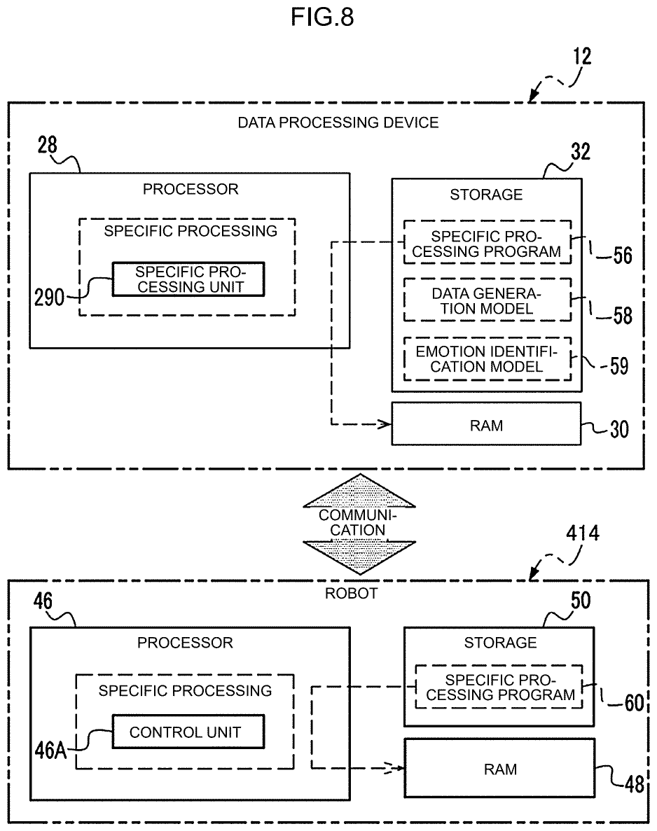

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned receiving unit, analysis unit, posting unit, minutes creation unit, and proposal unit is implemented by at least one of, for example, a robot 414 and a data processing apparatus 12. For example, the receiving unit is implemented by a microphone 238 and a control unit 46A of the robot 414, and receives questions by analyzing a user's utterance using speech recognition technology. The analysis unit is implemented, for example, by a specific processing unit 290 of the data processing apparatus 12, and generates appropriate answers to questions based on pre-learned data. The posting unit is implemented, for example, by the control unit 46A of the robot 414, and posts the generated answers to the chat field. The minutes creation unit is implemented, for example, by the specific processing unit 290 of the data processing apparatus 12, and summarizes the content of the meeting to generate minutes. The proposal unit is implemented, for example, by the specific processing unit 290 of the data processing apparatus 12, and analyzes the content of the meeting to propose next actions for unresolved issues. The correspondence between each unit and the apparatus or control unit is not limited to the above examples, and various modifications are possible.

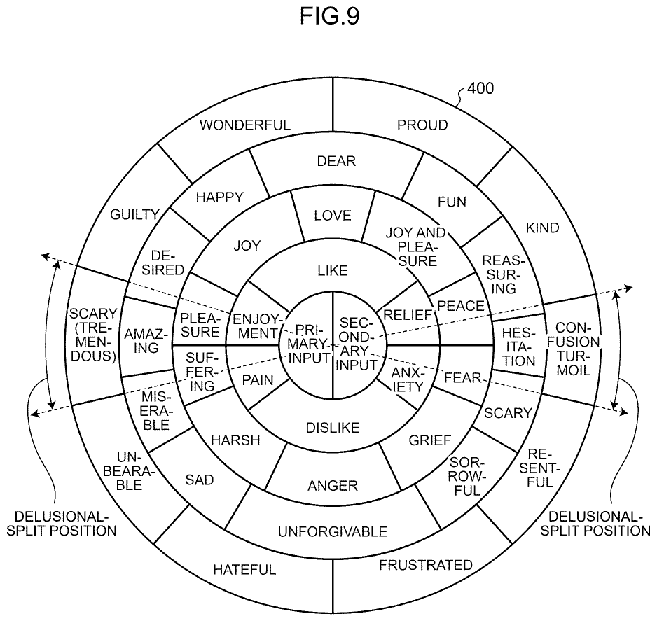

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

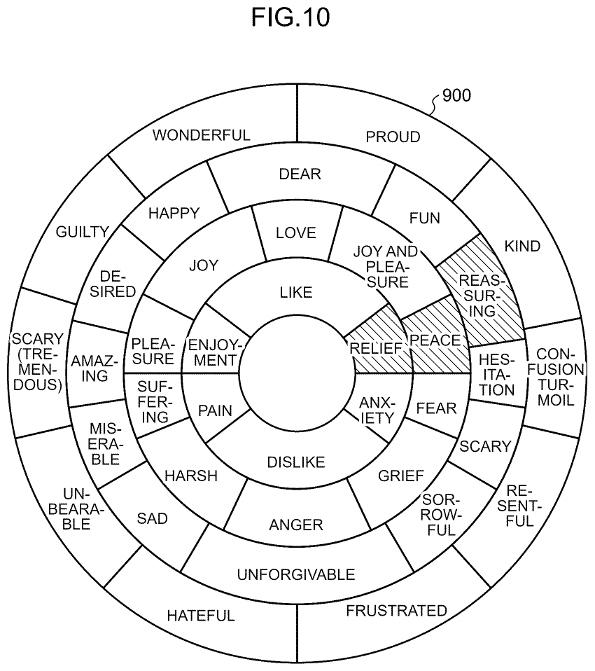

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a receiving unit configured to receive questions; an analysis unit configured to analyze the questions received by the receiving unit and generate answers; a posting unit configured to post the answers generated by the analysis unit to a chat field; a minutes creation unit configured to analyze video data of a meeting and create minutes; and a proposal unit configured to propose next actions based on the minutes created by the minutes creation unit.
(Supplementary Note 2)The system according to Supplementary Note 1, wherein the receiving unit is configured to receive questions by a user making an inquiry during a web conference.
(Supplementary Note 3)The system according to Supplementary Note 1, wherein the analysis unit is configured to generate appropriate answers to questions based on pre-learned data.
(Supplementary Note 4)The system according to Supplementary Note 1, wherein the posting unit is configured to post the generated answers to the chat field.
(Supplementary Note 5)The system according to Supplementary Note 1, wherein the minutes creation unit is configured to summarize the content of the meeting and output it as minutes.
(Supplementary Note 6)The system according to Supplementary Note 1, wherein the proposal unit is configured to analyze the content of the meeting and propose next actions for unresolved issues.
(Supplementary Note 7)The system according to Supplementary Note 1, wherein the receiving unit is configured to estimate the user's emotion and adjust the timing of receiving questions based on the estimated emotion of the user.
(Supplementary Note 8)The system according to Supplementary Note 1, wherein the receiving unit is configured to analyze the user's past question history and select an appropriate receiving method.
(Supplementary Note 9)The system according to Supplementary Note 1, wherein the receiving unit is configured to perform filtering at the time of receiving a question based on the user's current project or field of interest.
(Supplementary Note 10)The system according to Supplementary Note 1, wherein the receiving unit is configured to estimate the user's emotion and determine the priority of questions to be received based on the estimated emotion of the user.
(Supplementary Note 11)The system according to Supplementary Note 1, wherein the receiving unit is configured to prioritize receiving questions with high relevance based on the user's geographic location information at the time of receiving a question.
(Supplementary Note 12)The system according to Supplementary Note 1, wherein the receiving unit is configured to analyze the user's social media activity and receive relevant questions at the time of receiving a question.
(Supplementary Note 13)The system according to Supplementary Note 1, wherein the analysis unit is configured to estimate the user's emotion and adjust the expression method of answers based on the estimated emotion of the user.
(Supplementary Note 14)The system according to Supplementary Note 1, wherein the analysis unit is configured to adjust the level of detail of analysis based on the importance of the question at the time of analyzing the question.
(Supplementary Note 15)The system according to Supplementary Note 1, wherein the analysis unit is configured to apply different analysis algorithms according to the category of the question at the time of analyzing the question.
(Supplementary Note 16)The system according to Supplementary Note 1, wherein the analysis unit is configured to estimate the user's emotion and adjust the length of the answer based on the estimated emotion of the user.
(Supplementary Note 17)The system according to Supplementary Note 1, wherein the analysis unit is configured to determine the priority of analysis based on the submission timing of the question at the time of analyzing the question.
(Supplementary Note 18)The system according to Supplementary Note 1, wherein the analysis unit is configured to adjust the order of analysis based on the relevance of the question at the time of analyzing the question.
(Supplementary Note 19)The system according to Supplementary Note 1, wherein the posting unit is configured to estimate the user's emotion and adjust the timing of posting based on the estimated emotion of the user.
(Supplementary Note 20)The system according to Supplementary Note 1, wherein the posting unit is configured to adjust the level of detail of posting based on the importance of the answer at the time of posting.
(Supplementary Note 21)The system according to Supplementary Note 1, wherein the posting unit is configured to apply different posting algorithms according to the category of the answer at the time of posting.
(Supplementary Note 22)The system according to Supplementary Note 1, wherein the posting unit is configured to estimate the user's emotion and adjust the order of posting based on the estimated emotion of the user.
(Supplementary Note 23)The system according to Supplementary Note 1, wherein the posting unit is configured to determine the priority of posting based on the submission timing of the answer at the time of posting.
(Supplementary Note 24)The system according to Supplementary Note 1, wherein the posting unit is configured to adjust the order of posting based on the relevance of the answer at the time of posting.
(Supplementary Note 25)The system according to Supplementary Note 1, wherein the minutes creation unit is configured to estimate the user's emotion and adjust the expression method of the minutes based on the estimated emotion of the user.
(Supplementary Note 26)The system according to Supplementary Note 1, wherein the minutes creation unit is configured to adjust the level of detail of the minutes based on the importance of the meeting at the time of creating the minutes.
(Supplementary Note 27)The system according to Supplementary Note 1, wherein the minutes creation unit is configured to apply different minutes creation algorithms according to the category of the meeting at the time of creating the minutes.
(Supplementary Note 28)The system according to Supplementary Note 1, wherein the minutes creation unit is configured to estimate the user's emotion and adjust the length of the minutes based on the estimated emotion of the user.
(Supplementary Note 29)The system according to Supplementary Note 1, wherein the minutes creation unit is configured to determine the priority of the minutes based on the submission timing of the meeting at the time of creating the minutes.
(Supplementary Note 30)The system according to Supplementary Note 1, wherein the minutes creation unit is configured to adjust the order of the minutes based on the relevance of the meeting at the time of creating the minutes.
(Supplementary Note 31)The system according to Supplementary Note 1, wherein the proposal unit is configured to estimate the user's emotion and adjust the proposal method of next actions based on the estimated emotion of the user.
(Supplementary Note 32)The system according to Supplementary Note 1, wherein the proposal unit is configured to adjust the level of detail of proposals based on the importance of the meeting at the time of proposing next actions.
(Supplementary Note 33)The system according to Supplementary Note 1, wherein the proposal unit is configured to apply different proposal algorithms according to the category of the meeting at the time of proposing next actions.
(Supplementary Note 34)The system according to Supplementary Note 1, wherein the proposal unit is configured to estimate the user's emotion and determine the priority of next actions based on the estimated emotion of the user.
(Supplementary Note 35)The system according to Supplementary Note 1, wherein the proposal unit is configured to determine the priority of proposals based on the submission timing of the meeting at the time of proposing next actions.
(Supplementary Note 36)The system according to Supplementary Note 1, wherein the proposal unit is configured to adjust the order of proposals based on the relevance of the meeting at the time of proposing next actions.

What is claimed is:

1. A system comprising:
circuitry configured to:
receive, from a client terminal via a communication interface and a packet-switched network, audio data captured by a microphone of the client terminal during a video conference session;
convert the audio data into text data by inputting the audio data into a speech recognition model comprising at least one of a convolutional neural network or a recurrent neural network;
analyze the text data by inputting the text data into a natural language processing model to extract a query and generate response data comprising an answer to the query;
transmit the response data to the client terminal via the communication interface, the response data causing the client terminal to display the response data in a text display region;
receive, from the client terminal via the communication interface, video data of the video conference session;
generate summary data by inputting the video data into a data generation model obtained by deep learning on a neural network, the summary data comprising a condensed representation of content of the video conference session; and
generate action proposal data by analyzing the summary data to identify unresolved items and determining next actions for the unresolved items.

2. The system according to claim 1, wherein the circuitry is further configured to estimate an emotion of a user by applying an emotion identification model to the audio data, and to adjust a timing of receiving the audio data based on the estimated emotion.

3. The system according to claim 2, wherein when the estimated emotion indicates nervousness, the circuitry delays receiving the audio data, and when the estimated emotion indicates excitement, the circuitry receives the audio data immediately.

4. The system according to claim 1, wherein the circuitry is further configured to analyze a past query history of the user stored in a database and select an optimal receiving method for receiving subsequent audio data based on the past query history.

5. The system according to claim 1, wherein the circuitry is further configured to filter the audio data based on a current project or field of interest of the user, such that only audio data related to the current project or field of interest is processed.

6. The system according to claim 1, wherein the circuitry is further configured to estimate an emotion of a user by applying an emotion identification model to the audio data, and to adjust an expression method of the response data based on the estimated emotion, such that when the estimated emotion indicates nervousness, the circuitry generates concise response data, and when the estimated emotion indicates relaxation, the circuitry generates detailed response data.

7. The system according to claim 1, wherein the circuitry is further configured to adjust a level of detail of analyzing the text data based on an importance score associated with the query, such that for a query having a high importance score, the circuitry performs detailed analysis, and for a query having a low importance score, the circuitry performs concise analysis.

8. The system according to claim 1, wherein the circuitry is further configured to apply different analysis algorithms according to a category of the query, such that for a technical query, the circuitry applies a technical analysis algorithm, and for a business query, the circuitry applies a business analysis algorithm.

9. The system according to claim 1, wherein the circuitry is further configured to estimate an emotion of a user by applying an emotion identification model to the audio data, and to adjust a length of the response data based on the estimated emotion, such that when the estimated emotion indicates urgency, the circuitry generates a short response, and when the estimated emotion indicates relaxation, the circuitry generates a detailed response.

10. The system according to claim 1, wherein the circuitry is further configured to determine a priority of analyzing the text data based on a submission timing of the query, such that a more recently submitted query is analyzed with a higher priority.

11. The system according to claim 1, wherein the circuitry is further configured to estimate an emotion of a user by applying an emotion identification model to the audio data, and to adjust a timing of transmitting the response data based on the estimated emotion.

12. The system according to claim 1, wherein the circuitry is further configured to adjust a level of detail of the response data based on an importance score associated with the response data, such that for response data having a high importance score, the circuitry transmits detailed response data, and for response data having a low importance score, the circuitry transmits concise response data.

13. The system according to claim 1, wherein the circuitry is further configured to estimate an emotion of a user by applying an emotion identification model to the video data, and to adjust an expression method of the summary data based on the estimated emotion.

14. The system according to claim 1, wherein the circuitry is further configured to adjust a level of detail of the summary data based on an importance score associated with the video conference session, such that for a video conference session having a high importance score, the circuitry generates detailed summary data, and for a video conference session having a low importance score, the circuitry generates concise summary data.

15. The system according to claim 1, wherein the circuitry is further configured to apply different summary generation algorithms according to a category of the video conference session.

16. The system according to claim 1, wherein the circuitry is further configured to estimate an emotion of a user by applying an emotion identification model to sensor data received from the client terminal, and to adjust a proposal method of the action proposal data based on the estimated emotion, such that when the estimated emotion indicates nervousness, the circuitry generates concise action proposal data, and when the estimated emotion indicates relaxation, the circuitry generates detailed action proposal data.

17. The system according to claim 1, wherein the circuitry is further configured to adjust a level of detail of the action proposal data based on an importance score associated with the video conference session.

18. A system comprising:
a communication interface configured to communicate, via a packet-switched network conforming to at least one of a 5G, Wi-Fi, or Bluetooth communication standard, with a client terminal comprising a microphone, a speaker, a camera having a CMOS image sensor, and a display;
a processor;
a random-access memory;
a memory storing a data generation model obtained by deep learning on a neural network, a speech recognition model, a natural language processing model, and an emotion identification model;
a database; and
circuitry configured to:
receive, from the client terminal via the communication interface, audio data captured by the microphone during a video conference session;
convert the audio data into text data by inputting the audio data into the speech recognition model comprising at least one of a convolutional neural network or a recurrent neural network;
analyze the text data by inputting the text data into the natural language processing model to extract a query and generate response data;
estimate an emotion of a user by applying the emotion identification model to the audio data;
adjust at least one of a length, an expression method, or a level of detail of the response data based on the estimated emotion;
transmit the response data to the client terminal via the communication interface, the response data causing the client terminal to display the response data via the display;
receive, from the client terminal via the communication interface, video data of the video conference session captured by the camera;
generate summary data by inputting the video data into the data generation model; and
generate action proposal data by analyzing the summary data to identify unresolved items and determining next actions for the unresolved items.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model obtained by deep learning on a neural network, a speech recognition model, and a natural language processing model, the method comprising:
receiving, from a client terminal via the communication interface and a packet-switched network, audio data captured by a microphone of the client terminal during a video conference session;
converting the audio data into text data by inputting the audio data into the speech recognition model comprising at least one of a convolutional neural network or a recurrent neural network;
analyzing the text data by inputting the text data into the natural language processing model to extract a query and generating response data comprising an answer to the query;
transmitting the response data to the client terminal via the communication interface, the response data causing the client terminal to display the response data in a text display region;
receiving, from the client terminal via the communication interface, video data of the video conference session;
generating summary data by inputting the video data into the data generation model, the summary data comprising a condensed representation of content of the video conference session; and
generating action proposal data by analyzing the summary data to identify unresolved items and determining next actions for the unresolved items.
